(19) United States
(12) Patent Application Publication
(10) Pub. No.: US 2016/0253059 A1
(43) Pub. Date: Sep. 1, 2016

(54) Electronic Device and Operating Method Thereof

(71) Applicant: Samsung Electronics Co., Ltd., Suwon-si (KR)

(72) Inventor: Jihyun CHOI, Seoul (KR)

(21) Appl. No.: 15/052,106

(22) Filed: Feb. 24, 2016

(30) Foreign Application Priority Data
Feb. 27, 2015 (KR) 10-2015-0027960

(51) Int. Cl. G06F 3/0483; G06F 3/0484

(52) U.S. Cl. CPC G06F 3/0483; G06F 3/04842

(57) ABSTRACT

According to an embodiment, a method of operating an electronic device may include selecting a first page to delete from a plurality of pages, selecting a second page from the plurality of pages to which objects included in the first page are to be moved, moving the objects included in the first page to the second page, and deleting the first page. A method of operating an electronic device is not limited to the above method, and other embodiments can be made within the same or a similar scope of the present disclosure.

### RELATED APPLICATION(S)

This application claims priority under 35 U.S.C. §119(a) to Korean Application Serial No. 10-2015-0027960, which was filed in the Korean Intellectual Property Office on Feb. 27, 2015, the entire content of which is hereby incorporated by reference.

### BACKGROUND

Various embodiments of the present disclosure relate to an electronic device and an operating method thereof for processing a page displayed on a display.

An electronic device may display icons, texts, and/or images when displaying user interfaces on the display thereof. The electronic device may display the user interfaces on a screen that is divided into pages, and a plurality of pages may be displayed on the display. The electronic device may display one or more pages on one screen.

### SUMMARY

An electronic device, when displaying a user interface in a page configured to be displayed on the display thereof, may display an icon that corresponds to a program stored therein. Since the electronic device stores a plurality of programs, the electronic device may include a plurality of icons that correspond to the programs, and when displaying the icons on the display the electronic device may display various icons in two or more pages. The electronic device may increase or decrease the number of pages based on user input. In cases where the number of pages is decreased, a problem may occur when the icons in a page to be deleted are processed. For example, it may be inconvenient for a user to individually move icons in the page to be deleted to another page. Alternatively, if a page is deleted without moving the icons in the page, the programs that correspond to the deleted icons may also be deleted.

Various embodiments of the present disclosure may provide a method of moving an icon included in a page to another page and an electronic device using the same.

According to various embodiments, a method of operating an electronic device may include selecting a first page to delete from a plurality of pages, selecting from the plurality of pages a second page to which objects in the first page are to be moved, moving the objects to the second page, and deleting the first page.

According to various embodiments, an electronic device may include a display that displays at least one page, and a processor configured to: select a first page to delete from a plurality of pages, select a second page from the plurality of pages to which objects included in the first page are to be moved, move the objects included in the first page to the second page, and delete the first page.

According to various embodiments, an electronic device may include a computer readable storage medium having a program stored therein for performing selecting a first page to delete from a plurality of pages, selecting from the plurality of pages a second page to which objects in the first page are to be moved, moving the objects to the second page, and deleting the first page.

According to the various embodiments, the electronic device, when processing the movement of an icon displayed on the display thereof, can provide a user interface that performs a process in units of pages, thereby solving a user's inconvenience of repeatedly carrying out the same operation in order to move icons.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram illustrating a network environment including an electronic device, according to various embodiments of the present disclosure;

FIG. 2 is a flowchart illustrating an operation of moving an object in the electronic device, according to various embodiments of the present disclosure;

FIG. 3 illustrates an operation of displaying a page on the display of the electronic device, according to various embodiments of the present disclosure;

FIG. 4 illustrates an operation of displaying a page on the display of the electronic device, according to various embodiments of the present disclosure;

FIG. 5 illustrates an operation of moving an icon included in a page in the electronic device, according to various embodiments of the present disclosure;

FIG. 6 illustrates an operation of selecting a target page to move an icon included in a page in the electronic device, according to various embodiments of the present disclosure;

FIG. 7 illustrates an operation of selecting a page in the electronic device, according to various embodiments of the present disclosure;

FIG. 8 is a flowchart illustrating an operation of determining a page to move an object based on a priority in the electronic device, according to various embodiments of the present disclosure;

FIG. 9 illustrates the priorities assigned to pages in the electronic device, according to various embodiments of the present disclosure;

FIG. 10 is a flowchart illustrating an operation of determining a page to move an object based on attribute information in the electronic device, according to various embodiments of the present disclosure;

FIG. 11 illustrates an operation of moving an object in the electronic device, according to various embodiments of the present disclosure;

FIG. 12 is a flowchart illustrating an operation of moving an object to a page in the electronic device, according to various embodiments of the present disclosure;

FIG. 13 is a flowchart illustrating an operation of moving an object included in a page in the electronic device, according to various embodiments of the present disclosure;

FIG. 14 illustrates an operation of displaying a page on another page in the electronic device, according to various embodiments of the present disclosure;

FIG. 15 illustrates an operation of displaying a page on another page in the electronic device, according to various embodiments of the present disclosure;

FIG. 16 is a flowchart illustrating an operation of deleting a page in the electronic device, according to various embodiments of the present disclosure; and

FIG. 17 is a flowchart illustrating an operation of processing a plurality of pages in the electronic device, according to various embodiments of the present disclosure.

### DETAILED DESCRIPTION

Hereinafter, various embodiments of the present disclosure will be described in connection with the accompanying drawings.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications, equivalents, and/or alternatives within the spirit and scope of the present disclosure. In the description of the drawings, similar reference numerals may be used to designate similar elements.

The terms as used in various embodiments of the present disclosure are used merely to describe a certain embodiment and are not intended to limit the present disclosure. As used herein, singular forms may include plural forms as well unless the context explicitly indicates otherwise. As used in various embodiments of the present disclosure, the expressions “have,” “include,” “comprise” and other similar expressions are intended merely to denote a certain feature, numeral, step, operation, element, component, or a combination thereof, and should not be construed to exclude the existence of or a possibility of addition of one or more other features, numerals, steps, operations, elements, components, or combinations thereof.

Furthermore, as used in various embodiments of the present disclosure, the expression “and/or” includes any or all combinations of words enumerated together. For example, the expression “A and/or B” may be just A, may be just B, or may include both A and B.

In the present disclosure, expressions including ordinal numbers such as “first” and “second,” etc., may modify various elements. However, such elements are not limited by the above expressions. For example, the ordinal numbers do not limit the sequence and/or importance of the elements. The above expressions are used merely for the purpose of distinguishing an element from other elements. For example, a first user device and a second user device indicate different user devices although both of them are user devices. Accordingly, a first element may be termed a second element, and likewise a second element may be termed a first element without departing from the scope of the present disclosure.

When a first element is referred to as being “coupled” or “connected” to a second element, it should be understood that the first element may be coupled or connected directly to the second element, but also that one or more other elements may be interposed between the first element and the second element. When a first element is referred to as being “directly coupled” or “directly connected” to a second element, it should be understood that there is no other element in between the first element and the second element.

Furthermore, all terms used herein, including technical and scientific terms, have the same meaning as commonly understood by those of skill in the art to which the present disclosure pertains. Such terms as those defined in a generally used dictionary are to be interpreted to have the meanings equal to the contextual meanings in the relevant field of art, and are not to be interpreted otherwise unless clearly defined in the present disclosure.

An electronic device according to various embodiments of the present disclosure may be a device including a display (or a display including a touch screen). The electronic device according to various embodiments of the present disclosure may, for example, include at least one of a smart phone, a tablet personal computer (PC), a mobile phone, a video phone, an e-book reader, a desktop PC, a laptop PC, a netbook computer, a personal digital assistant (PDA), a portable multimedia player (PMP), an MP3 player, a mobile medical device, a camera, a wearable device (e.g., a head-mount-device (HMD) such as electronic glasses, electronic clothing, an electronic bracelet, an electronic necklace, an electronic appcessory, an electronic tattoo, or a smart watch), a television, a digital video disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an artificial intelligence robot, a Television (TV), an electronic dictionary, an electronic key, a camcorder, medical equipment (e.g., a magnetic resonance angiography (MRA) machine, a magnetic resonance imaging (MRI) machine, a computed tomography (CT) scanner, or an ultrasonic machine), a navigation device, a global positioning system (GPS) receiver, an event data recorder (EDR), a flight data recorder (FDR), a vehicle infotainment device, electronic equipment for a ship (e.g., ship navigation equipment and a gyrocompass), avionics, security equipment, an industrial or home robot, a part of furniture or building/structure, an electronic board, an electronic signature receiving device, a projector, and various measuring instruments (e.g., a water meter, an electricity meter, a gas meter, or a wave meter). The electronic device according to various embodiments of the present disclosure may be a combination of one or more of the aforementioned various devices. The electronic device according to various embodiments of the present disclosure may be a flexible device. Furthermore, it will be apparent to those skilled in the art that the electronic device according to various embodiments of the present disclosure is not limited to the aforementioned devices.

Hereinafter, an electronic device according to various embodiments of the present disclosure will be described with reference to the accompanying drawings. The term “user” as used in various embodiments of the present disclosure may indicate a person who uses an electronic device or a device (e.g., artificial intelligence electronic device) that uses an electronic device.

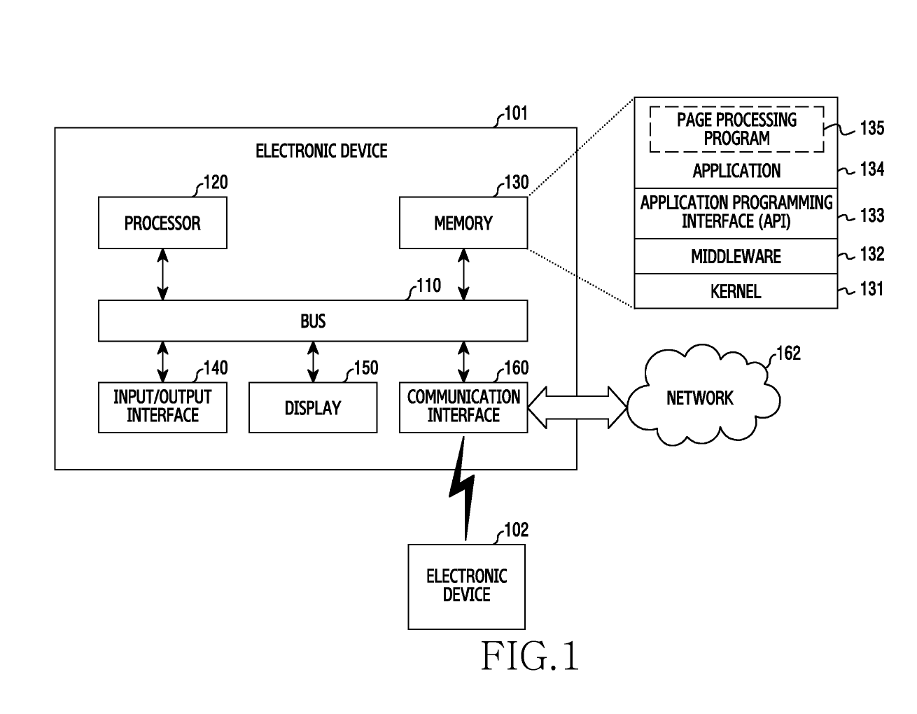

FIG. 1 is a block diagram illustrating a network environment including an electronic device, according to various embodiments of the present disclosure.

Referring to FIG. 1, the electronic device 101 may include at least one of a bus 110, a processor 120, a memory 130, an input/output interface 140, a display 150, and a communication interface 160.

The bus 110 may be a circuit that interconnects the other elements and transfers communication signals (e.g., control messages) between various elements.

The processor 120 may, for example, receive instructions from other elements (e.g., the memory 130, the input/output interface 140, the display 150, and/or the communication interface 160) via the bus 110, decode the received instructions, and perform calculations or data processing according to the decoded instructions.

At least one processor 120 may be included in the electronic device 101 to perform a specified function of the electronic device 101. According to an embodiment, the processor 120 may include one or more Application Processors (APs) and/or one or more Micro Controller Units (MCUs). According to another embodiment, the processor 120 may include one or more micro controllers as applications, or may be functionally connected to one or more micro controllers. According to an embodiment, the APs and the MCUs may be in a single IC package, or may be in different IC packages. According to an embodiment, the MCU(s) may be included in the same IC package as the AP(s). Although the processor 120 is described as including the APs and/or the MCUs as elements thereof, those are just examples of different possible configurations. The processor 120 may comprise other types of processing units.

The APs may control a plurality of hardware or software elements and may perform processing and operations on various types of data including multimedia data by executing an operating system or application programs (or applications). The APs may be embodied as, for example, a System on Chip (SoC). According to an embodiment, the processor 120 may further include a Graphic Processing Unit (GPU, not illustrated).

The MCUs may be processors that are configured to perform specified operations. According to an embodiment, the MCUs may acquire sensing information through one or more specified motion sensors (e.g., a gyro sensor, an acceleration sensor, and a geomagnetic sensor), compare the acquired sensing information; and determine the operating states of the specified sensors with reference to a database of the electronic device 101.

According to an embodiment, the APs and/or the MCUs may load instructions and/or data received from at least one of non-volatile memories and volatile memories, and may process the loaded instructions or data. Furthermore, the APs or the MCUs may store in non-volatile memories the data received from, or generated by, at least one of the other elements.

The memory 130 may store instructions or data received from, or generated by, the processor 120 or the other elements (e.g., the input/output interface 140, the display 150, and the communication interface 160). The memory 130 may include programming modules such as, for example, a kernel 131, middleware 132, an Application Programming Interface (API) 133, applications 134, etc. The programming modules may be configured with software, firmware, hardware, or a combination of two or more thereof.

The kernel 131 may control or manage system resources (e.g., the bus 110, the processor 120, the memory 130, etc.) that are used to execute operations or functions implemented in programming modules such as, for example, the middleware 132, the API 133, and the applications 134. Also, the kernel 131 may provide an interface that allows the middleware 132, the API 133, and/or the applications 134 to access, control, or manage individual elements of the electronic device 101.

The middleware 132 may function as an intermediary that allows the API 133 and/or the applications 134 to communicate with the kernel 131 in order to exchange data. Furthermore, in regard to task requests received from, for example, the applications 134, the middleware 132 may control (e.g., scheduling or load balancing) the task requests by using, for example, a method of assigning a priority to use the system resources of the electronic device 101 (e.g., the bus 110, the processor 120, the memory 130, etc.).

The API 133, which is an interface for allowing the applications 134 to control functions provided by the kernel 131 or the middleware 132, may include, for example, at least one interface or function (e.g., instruction) for a file control, a window control, image processing, a text control, etc.

The applications 134 may include, for example, a Short Message Service (SMS)/Multimedia Message Service (MMS) application, an e-mail application, a calendar application, an alarm application, a health care application (e.g., an application for measuring physical activity, blood glucose, etc.), and an environmental information application (e.g., an application for providing atmospheric pressure, humidity, or temperature information). The applications 134 may include an application associated with information exchange between the electronic device 101 and an external electronic device (e.g., the electronic device 102). The application associated with the exchange of information may include, for example, a notification relay application for transferring specific information to an external electronic device or a device management application for managing an external electronic device. The notification relay application may include a function of transferring to an external electronic device (e.g., the electronic device 102) notification information generated by the other applications (e.g., the SMS/MMS application, the e-mail application, the health care application, the environmental information application, etc.) of the electronic device 101.

Additionally or alternatively, the notification relay application may receive notification information from, for example, an external electronic device (e.g., the electronic device 102) and may provide the received notification information to a user. The device management application may, for example, manage (e.g., install, delete, or update) functions for at least a part of an external electronic device (e.g., the electronic device 102) that communicates with the electronic device 101 (e.g., turning on/off the external electronic device itself and/or some elements thereof, adjusting the brightness and/or resolution of a display, etc.), applications that operate in the external electronic device, services (e.g., a telephone call service or a message service) that are provided by the external electronic device, and the like.

According to various embodiments, the applications 134 may include an application that is designated based on the properties (e.g., the type) of an external electronic device (e.g., the electronic device 102). For example, in cases where an external electronic device is an MP3 player, the applications 134 may include an application relating to the reproduction of music. Similarly, in cases where an external electronic device is a mobile medical appliance, the applications 134 may include an application relating to health care. According to an embodiment, the applications 134 may include at least one of applications specific to the electronic device 101 and applications received from an external electronic device (e.g., a server). A page processing program 135 may be included in the applications 134, or may be stored, as a separate program, in the memory 130.

The page processing program 135 may output on a display a plurality of pages that include one or more icons, perform a process to select first and second pages from the plurality of pages to move the icons from the first page to the second page and arrange and display the icons in the second page. The page processing program 135 may display one or more pages at a time. According to an embodiment, the page processing program 135 may delete the first page when all the icons in the first page have been moved. According to an embodiment, the page processing program 135 may select the first and second pages based on an input for selecting the first page and deleting the first page. According to an embodiment, the page processing program 135 may select the first and second pages based on an input for moving the first and second pages. According to an embodiment, the page processing program 135 may select the second page based on attribute information of the icons included in the first page. According to an embodiment, the page processing program 135 may dispose the first page in a partial area of the second page. According to an embodiment, the page processing program 135 may include the icons of the first page in a folder and may move the folder to the second page. According to an embodiment, the page processing program 135 may include the icons of the first page in two or more folders. According to an embodiment, the page processing program 135 may select a third page and may move some of the icons from the first page to the third page to arrange the icons in the third page.

The input/output interface 140 may transfer instructions or data, which are input from a user through an input/output device (e.g., various sensors, such as an acceleration sensor and a gyro sensor, and/or a device, such as a keyboard or a touch screen), to the processor 120, the memory 130, or the communication interface 160 through the bus 110. For example, the input/output interface 140 may provide to the processor 120 data on a user's touch that is entered on a touch screen. Furthermore, the input/output interface 140 may output instructions or data, which are received from, for example, the processor 120, the memory 130, and/or the communication interface 160 via the bus 110, through an output unit (e.g., a speaker or a display). For example, the input/output interface 140 may output voice data, which is processed by the processor 120, to a user through a speaker.

The display 150 may display various types of information (e.g., multimedia data or text data) to a user. Furthermore, the display 150 may also be configured with a touch screen to which an instruction is input by a touch or proximity touch of an input means on a display.

The communication interface 160 (e.g., a communication module) may establish a communication connection between the electronic device 101 and an external device (e.g., a server). For example, the communication interface 160 may be connected to a network 162 through wireless or wired communication to communicate with an external device. The wireless communication may include at least one of, for example, Wi-Fi, Bluetooth (BT), Near Field Communication (NFC), a Global Positioning System (GPS), and cellular communication (e.g., LTE, LTE-A, CDMA, WCDMA, UMTS, WiBro, GSM, etc.). The wired communication may include at least one of, for example, a Universal Serial Bus (USB), a High Definition Multimedia Interface (HDMI), Recommended Standard 232 (RS-232), and a Plain Old Telephone Service (POTS).

According to an embodiment, the network 162 may be a telecommunication network. The telecommunication network may include at least one of a computer network, the Internet, the Internet of Things, and a telephone network. According to an embodiment, at least one of the applications 134, the application programming interface 133, the middleware 132, the kernel 131, and the communication interface 160 may support a protocol (e.g., a transport layer protocol, a data link layer protocol, and/or a physical layer protocol) for communication between the electronic device 101 and an external device.

According to an embodiment, the electronic device 102 (which may be, for example, a server) may support the electronic device 101 by performing at least one of the operations (or functions) that are implemented in the electronic device 101. For example, the electronic device 102 may include a server module (e.g., a server controller or a server processor, not illustrated) that may support the processor 120 that controls the electronic device 101 to perform various embodiments of the present disclosure, which will be described below, or may support a specific module that is specified to perform the various embodiments. For example, the server module of the electronic device 102 may include at least one element of the processor 120 or the specific module to perform at least one of the operations that are performed by the processor 120 or the specific module (e.g., to perform at least one of the operations on behalf of the processor 120 or the specific module). According to various embodiments, the server module may be represented as the page processing program 135 of FIG. 1.

According to various embodiments, the electronic device 101 may display a User Interface (UI), such as an icon, an image, a text, and a link, on the display 150. When displaying the user interface on the display 150, such as an icon, the electronic device 101 may display the user interface in a page that is configured with at least one layer. Herein, a plurality of pages may be configured, and the electronic device 101 may display at least one of the plurality of pages on the display 150 based on a user input that is entered thereon. The user input may be detected through the input/output interface 140 and/or the touch screen of the display 150 of the electronic device 101.

According to various embodiments, one page may be configured to include a user interface, such as an icon. However, it is apparent that the page does not necessarily have to include a user interface and may also be configured as an empty page. In this case, the electronic device 101 may display the empty page based on a user input.

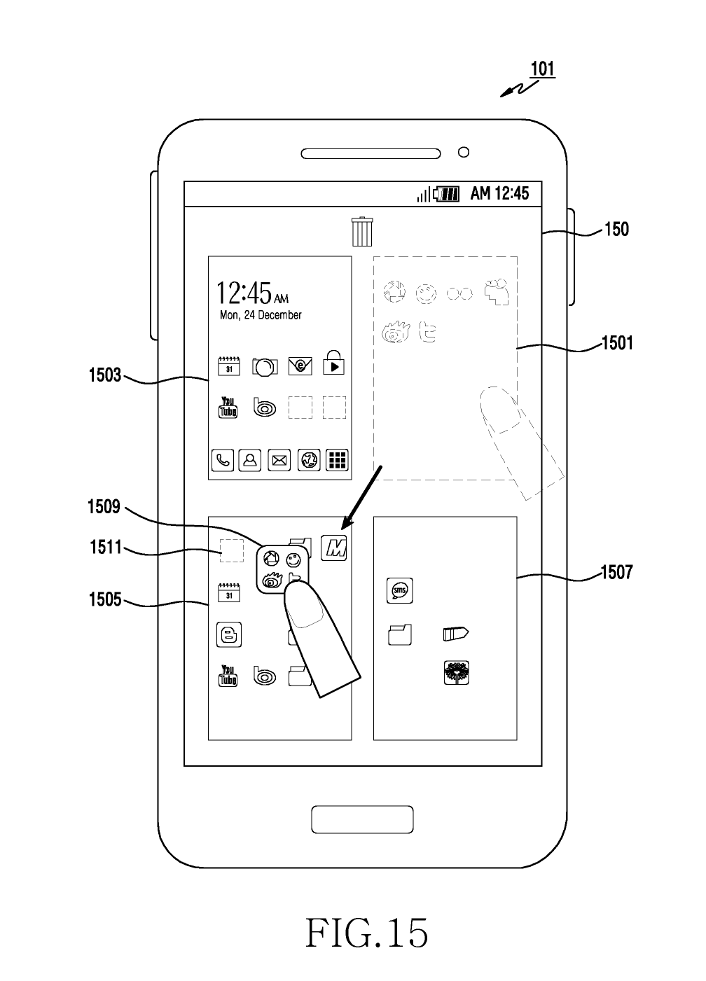

According to various embodiments, the electronic device 101 may select one page (e.g., may select a page 1505 of FIG. 15) based on a user input while a plurality of pages are displayed at the same time as illustrated in FIG. 15, and may display the selected page (e.g., may display the magnified image) on the display 150.

According to various embodiments, the electronic device 101 may display a plurality of pages on the display 150, and may detect the occurrence of an event for selecting at least one page and deleting or moving (or disposing) the selected page. In the following description, the electronic device 101 is illustrated as independently moving (or disposing) each of the objects (e.g., an icon, a text, an image, a table, a graph, etc.) displayed in the first page to another of the plurality of pages (e.g., the second, third page, fourth page, etc.). However, without being limited to moving an icon, the electronic device 101 may display the icon in the page to which the icon is moved. Herein, the objects displayed on the display 150 are targets that may be displayed and/or selected as a graphic interface on the display 150, such as an icon, a text, an image, a table, a graph, etc., and may be described as icons in the following description.

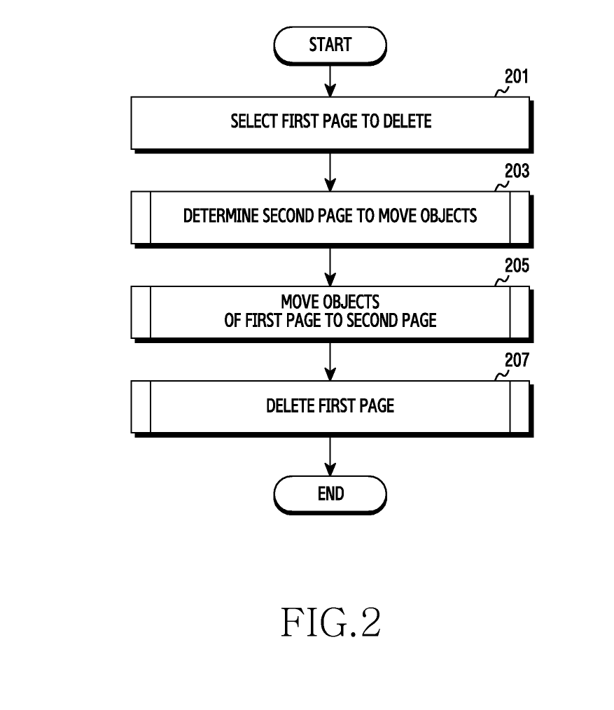

Additional information on the electronic device 101 will be provided through FIGS. 2 to 17, which will be described below.

FIG. 2 is a flowchart illustrating an operation of processing a plurality of pages in the electronic device, according to various embodiments of the present disclosure.

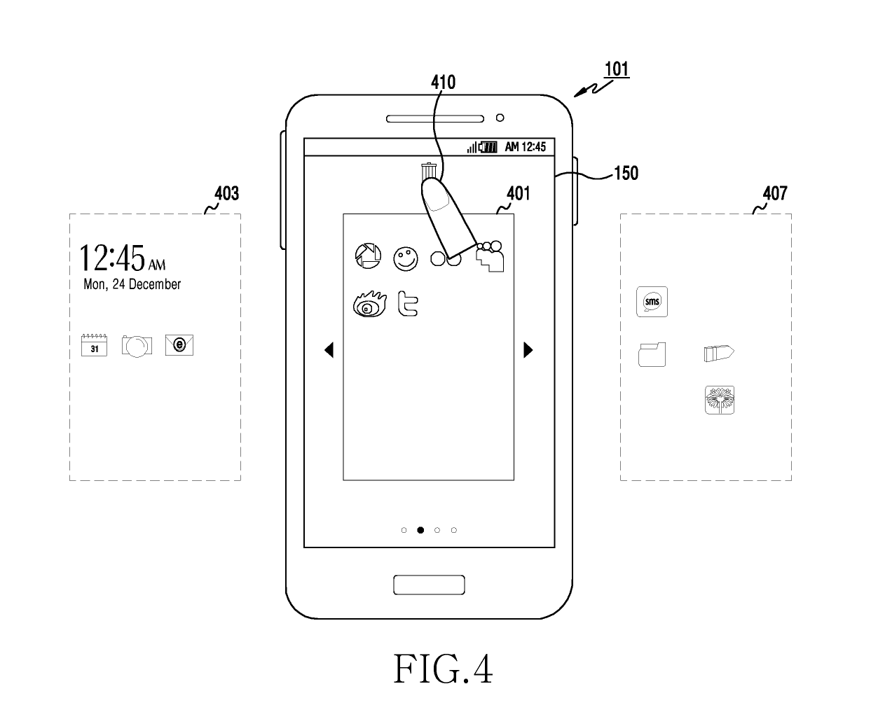

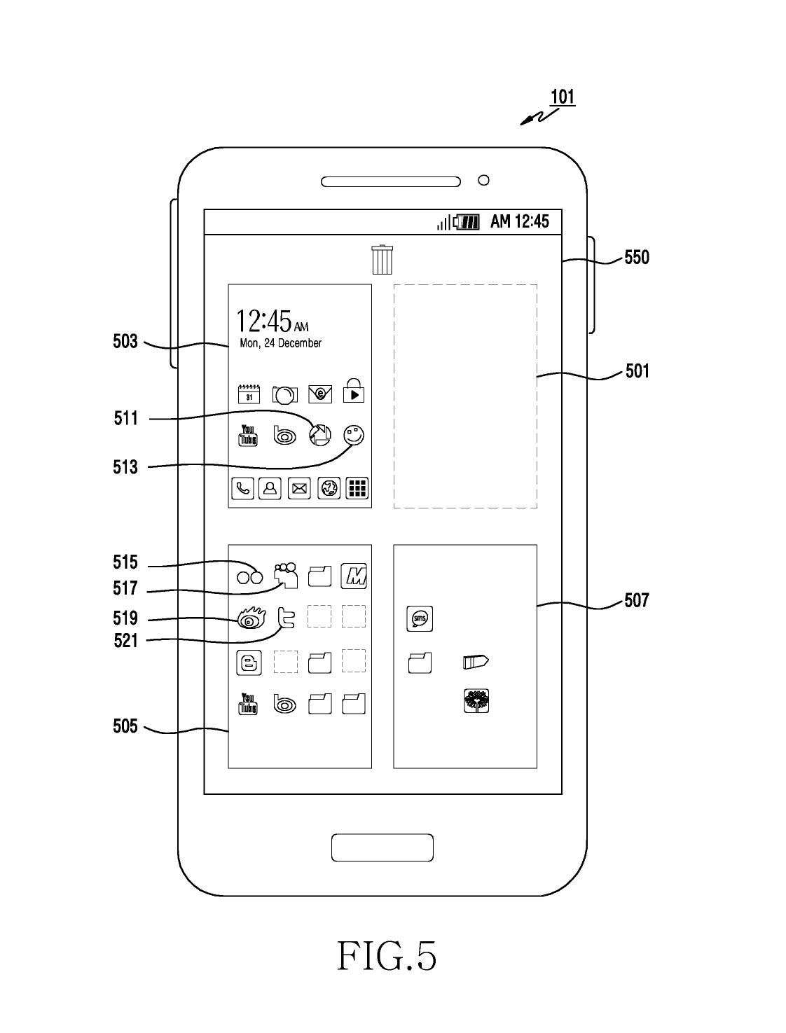

Referring to operation 201, the electronic device 101 may select at least one page (e.g., a first page) as a page to delete, from a plurality of pages that can be displayed on the display 150. According to an embodiment, the electronic device 101 may display at one time a page on the display 150. The page displayed may be, for example, one of several pages that can be displayed on the display 150. Also, as can be seen in FIG. 5, several pages may be displayed at the same time on the display 150. Referring to FIG. 4, the electronic device 101 may display, on the display 150, one of a plurality of pages that include at least one user interface (e.g., icon). The electronic device 101 may display one of page 401, page 403, and page 407 on the display 150. Herein, each page may include at least one user interface (e.g., icon). Although the electronic device 101 displays the three pages 401, 403, and 407 on the display 150, in cases where an additional page is configured, the electronic device 101, without being limited thereto, may display the additional page (not illustrated) along with the three pages 401, 403, and 407 in one window of the display 150, or the additional page may be displayed separately in another window of the display 150. Prior to performing the operation of displaying at least one page on the display 150 as described above, the electronic device 101 may perform the operation of selecting the first page to delete in operation 201.

According to an embodiment, the electronic device 101 may display at least one of a plurality of pages that can be displayed on the display 150. For example, referring to FIG. 5, the electronic device 101 may display, on the display 150, one page (e.g., a page 501) from among page 501, page 503, page 505, and page 507 of FIG. 5. Herein, the page (e.g., page 501) displayed on the display 150 may include at least one user interface (e.g., icon). Referring to FIG. 5, although the electronic device 101 is illustrated as displaying one (e.g., page 501) of the four pages 501, 503, 505, and 507 on the display 150, in cases where an additional page is configured, the electronic device 101 may configure displayable pages, including the additional page (not illustrated), on the display 150 without being limited thereto. The electronic device 101 may display a page other than the page (e.g., page 401) currently on the display 150 in response to user input, such as a touch, a drag, etc., which is input to the touch screen of the display 150. In the following description, pages configured to be displayed on the display 150 may be selected from a plurality of pages that are currently displayed on the display 150 of the electronic device 101 and/or pages that are not currently displayed on the display 150.

According to various embodiments, the electronic device 101 may select a page displayed on the display 150 as a page to delete. According to an embodiment, in a method of selecting a page, the electronic device 101 may select the page where the user input is detected, where the user input may be touching the page to be deleted. For example, referring to FIG. 4, the electronic device 101 may select page 401 presently displayed based on a user input of touching page 401. The touch input may be, for example, a single tap, a double tap, or a touch that is maintained for a specified period of time, and may be design and/or implementation dependent, or user selectable. Support for the various types of touches allowed may be stored in the setting information to allow a user to choose the method of selecting a page based on a touch.

The electronic device 101 may determine whether a user input generated through the input/output interface 140 and/or the touch screen of the display 150 corresponds to an input for deleting the selected first page. According to an embodiment, the electronic device 101 may detect an operation of selecting at least one first page among the plurality of pages displayed on the display 150 and selecting a deletion icon displayed on the display 150. For example, referring to FIG. 4, the electronic device 101 may detect an input for selecting a recycle bin 410 when page 401 has been selected as the first page by user input.

In the method of selecting at least one first page (e.g., page 401) and selecting a recycle bin (e.g., recycle bin 410), the electronic device 101 may detect a user input for touching page 401 displayed on the display 150, dragging page 401 to the recycle bin 410while maintaining the touch, and releasing the touch at the recycle bin. Alternatively, the electronic device 101 may detect a user input for selecting page 401 by touching page 401 displayed on the display 150, followed by detecting that specified time (e.g., 1 second) has elapsed while the touch is maintained, and touching the recycle bin 410. In another case, the electronic device 101 may detect a user input for selecting page 401 by touching the check box that corresponds to page 401 that may be displayed on the display 150, and touching the recycle bin 410. When the electronic device 101 detects an input for deleting the selected first page as described above, the electronic device 101 may select the selected first page (e.g., page 401) as a page to delete.

Referring to operation 203, the electronic device 101 may select a second page to move icons included in the first page that has been selected to be deleted. The electronic device 101 may select at least one page as the second page based on page information included in a database. According to an embodiment the electronic device 101 may select the second page based on priorities that are set for the respective pages, or may select the second page based on at least one of attribute information of the icons included in the first page (or attribute information of programs relating to the icons), attribute information of pages that are configured to be displayed on the display 150, and/or attribute information of icons included in the pages that are configured to be displayed on the display 150.

Referring to operation 205, the electronic device 101 may move to the second page one or more objects (e.g., icons) that are included in the first page (e.g., page 401) to be deleted. For example, the operation of moving the icons included in the first page to the second page may include an operation of selecting at least one second page and an operation of moving the icons included in the first page to the selected second page. The electronic device 101 may move the icons displayed in the first page to the second page to display the icons in the second page, may move the first page to the second page to display the first page in a partial area of the second page, and/or may move a folder that includes the icons of the first page to the second page to display the folder in the second page.

The electronic device 101 may move to the selected second page the icons displayed in the first page that has been selected to be deleted. For example, referring to FIG. 5, when the electronic device 101 detects a user input for deleting page 501, the electronic device 101 may move page 501 (or at least one icon included in the selected page 501) to at least one second page.

Referring to operation 207, the electronic device 101 may delete the first page from which the icons have been moved. According to an embodiment, the electronic device 101 may identify whether an icon is included in the first page that has been selected to be deleted. For example, when moving the icons included in the first page to the second page, the electronic device 101 may identify whether the first page includes at least one icon, and when determining that the first page includes icons, the electronic device 101 may repeatedly perform the operation of moving an icon included in the first page to at least one second page. The electronic device 101 may then delete the first page when it is identified that no icon is left in the first page. Accordingly, the electronic device 101 may delete the first page right away when it initially determines that the first page does not include any object.

The operation may end after the first page is deleted in operation 207.

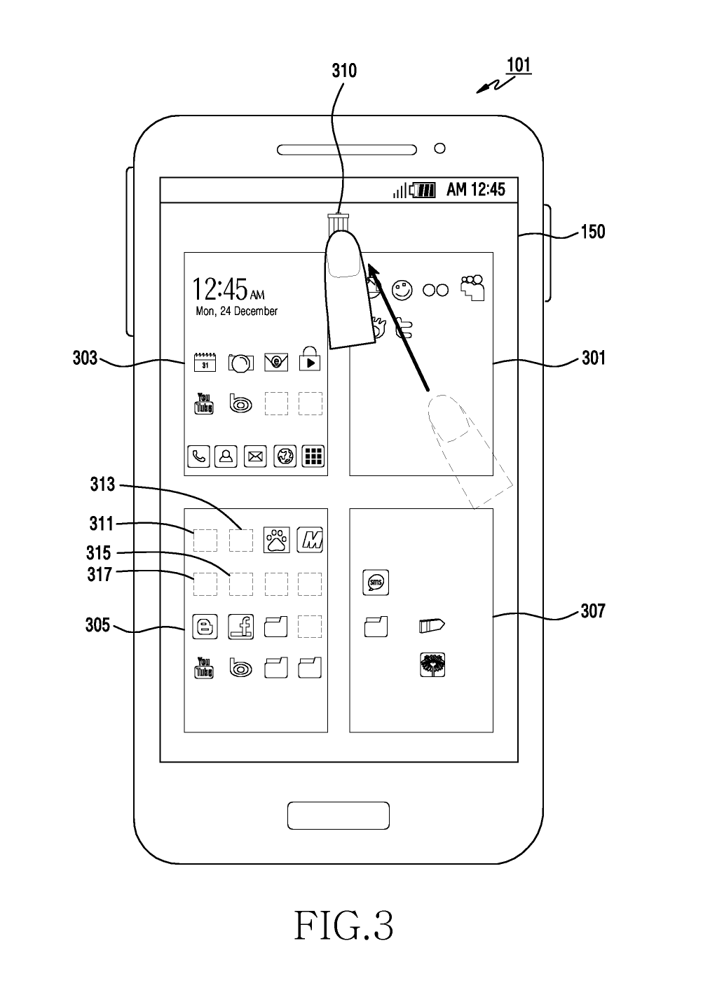

FIG. 3 illustrates an operation of displaying a page on the display of the electronic device, according to various embodiments of the present disclosure.

According to various embodiments, the electronic device 101 may display at least one page on the display 150. According to an embodiment, the electronic device 101 may detect a user input to display two or more pages rather than the single page currently displayed on the display 150, and may display multiple pages on the display 150. For example, referring to FIG. 3, the electronic device 101 may display four pages (e.g., pages 301, 303, 305, and 307) from among the pages that can be displayed on the display 150. In cases where additional pages are included in addition to the pages displayed on the display 150, the electronic device 101 may display the other pages based on a user input (e.g., a drag). The user may drag, for example, the other page(s) to where the current page is displayed.

At least one of the pages specified to be displayed on the display 150 of the electronic device 101 may include one or more icons. When displaying icons in one page, the electronic device 101 may arrange the icons based on a specified method in the setting information of the electronic device 101. Alternatively, the electronic device 101 may change the location of at least one of the icons displayed on the display 150 based on a user input. In another case, the electronic device 101 may keep an area of a page free of icons. For example, referring to page 305, the electronic device 101 may maintain at least one area, such as an area 311, an area 313, an area 315, and/or an area 317, free of icons when displaying icons on the display 150.

According to various embodiments, the electronic device 101 may display on the display 150 a menu (e.g., a recycling bin icon 310) by which at least one page may be deleted based on a user input. The recycling bin icon 310 may be used by the user to indicate to the electronic device 101 the page(s) to delete. According to an embodiment, the electronic device 101 may select at least one of the pages that can be displayed on the display 150 and may delete the selected page(s) by selecting the recycling bin icon 310. In cases where the selected page includes at least one icon, the electronic device 101 may move the icon to at least one other page before deleting the selected page. When there is no icon left to be moved in the selected page, the electronic device 101 may delete the selected page.

FIG. 4 illustrates an operation of displaying a page on the display of the electronic device, according to various embodiments of the present disclosure.

According to various embodiments, the electronic device 101 may display on the display 150 one of the pages that can be displayed. For example, the electronic device 101 may display one page (e.g., page 401) from among a plurality of pages (e.g., page 401, 403, and 407) on the display 150 based on the setting information. When displaying the selected page (e.g., page 401) on the display 150, the electronic device 101 may also display in an area of the display 150 at least one menu (e.g., a recycle bin 410 for controlling to delete a page) that can control the selected page (e.g., page 401).

Based on an input detected through the input/output interface 140 and/or the touch panel of the display 150, the electronic device 101 may display one of the pages (e.g., page 403 and page 407) that are not currently displayed on the display 150. For example, based on a drag input that is entered through the touch screen of the display 150, the electronic device 101 may display the preceding page (e.g., page 403) or the next page (e.g., page 407) of the displayed page (e.g., page 401) on the display 150.

FIG. 5 illustrates an operation of moving an icon included in a page in the electronic device, according to various embodiments of the present disclosure.

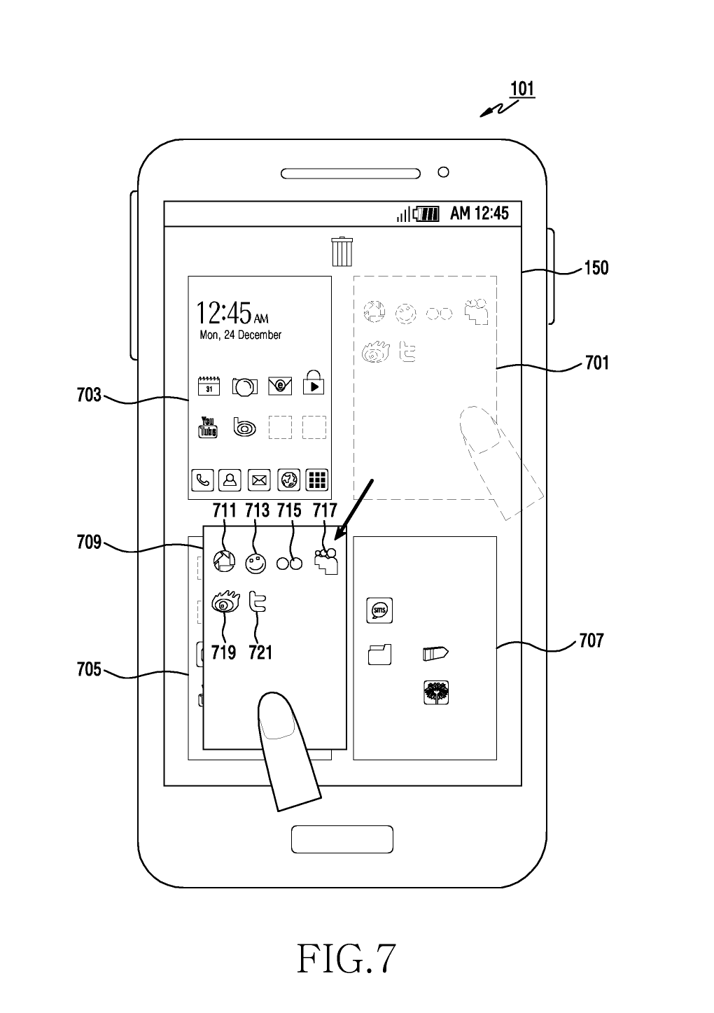

According to an embodiment, the electronic device 101 may detect a user input for selecting and deleting a first page (e.g., page 301 of FIG. 3), or a user input for moving a first page to a second page (e.g., page 709 of FIG. 7). While the electronic device 101 is in the process of moving icons from the first page to the second page, the electronic device 101 may determine that the second page (e.g., page 503) has no space where the remaining icons in the first page. For example, the electronic device 101 may have moved, for example, icons 511 and 513 from the first page to the second page (e.g., page 503), and then determined that the second page 503 has no space for more icons. The electronic device 101 may then select another page that has space for at least one icon, as a third page, from the pages specified to be displayed on the display 150. The electronic device 101 may move the remaining icons (e.g., icons 515, 517, 519, and 521) from the first page to the selected third page (e.g., page 505).

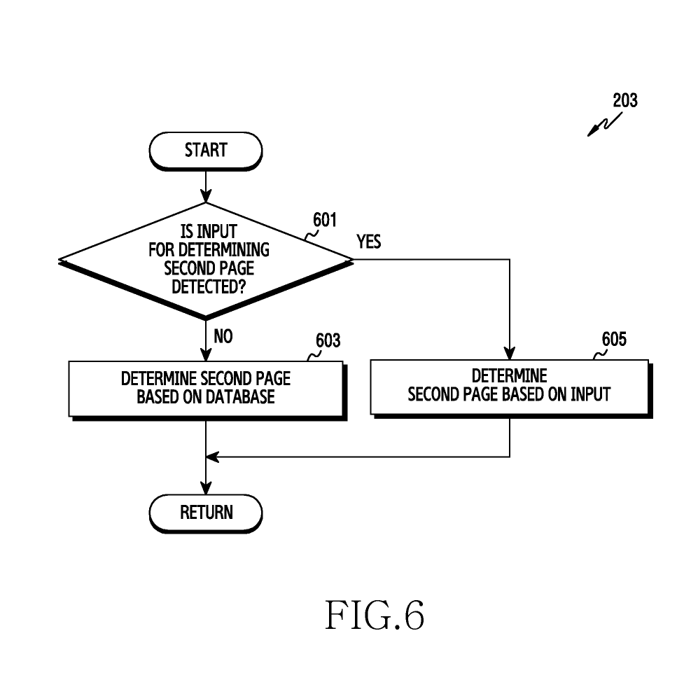

FIG. 6 illustrates an operation of selecting a target page to move an icon included in a page in the electronic device, according to various embodiments of the present disclosure.

Referring to operation 601, when selecting the second page to receive the icons from the first page, where the first page is to be deleted, the electronic device 101 may identify the second page based on a user input to the input/output interface 140 and/or the touch screen of the display 150. The electronic device 101 may identify the second page based on an input for selecting the second page within a specified period of time after the first page is selected. The electronic device 101 may perform operation 603 when an input is not detected for selecting the second page, and may perform operation 605 when an input is detected for selecting the second page.

Referring to operation 603, the electronic device 101 may select at least one page as the second page based on page information included in a database. According to an embodiment, the electronic device 101 may select the second page based on at least one of attribute information of the icons included in the first page (or attribute information of programs relating to the icons), attribute information of pages that are configured to be displayed on the display 150, and/or attribute information of icons included in the pages that are configured to be displayed on the display 150.

Referring to operation 605, the electronic device 101 may select at least one page from the pages (e.g., pages 701, 703, 705, and 707) displayed on the display 150 and may detect a user input for moving icons from the selected page to another page. According to an embodiment, the electronic device 101 may select the first page (e.g., page 701) from the pages displayed on the display 150 based on a touch, and may detect a user input for moving (or superposing) the selected first page (e.g., page 701) to the second page (e.g., page 705) based on a drag (e.g., by moving an input means while the touch of the input means on the display 150 is maintained). Namely, the electronic device 101 may detect the movement of the input for selecting the first page. For example, when detecting an input for moving the selected first page (e.g., page 701) to the second page (e.g., page 705), the electronic device 101 may detect an input for touching the first page (e.g., page 701), dragging the selected first page (e.g., page 701) to the second page (e.g., page 705), and releasing the first page when it overlaps with the second page with a specified overlapping percentage (e.g., by more than 70% of the area of the first page). Namely, the electronic device 101 may detect the release of the input and may select the page corresponding to the location of the released input as the second page.

The electronic device 101 may end an embodiment of the disclosure described in FIG. 6 after performing operation 603 or 605.

According to various embodiments, the electronic device 101 may perform at least one of the operations 601 and 605 of FIG. 6 as a sub-routine for the operation 203 of FIG. 2. In cases where the electronic device 101 performs the operations of FIG. 6 as a sub-routine for the operation 203 of FIG. 2, the electronic device 101 may perform the operation 601 after the operation 201 of FIG. 2 and may perform the operation 205 after the operation 603 or 605.

FIG. 7 illustrates an operation of selecting a page in the electronic device, according to various embodiments of the present disclosure.

According to various embodiments, the electronic device 101 may select at least one of the pages (e.g., pages 701, 703, 705, and 707) that are displayed on the display 150 and may display on the display 150 an interface that corresponds to a user input for moving the selected page to another page. According to an embodiment, the first page (e.g., page 701) from the pages displayed on the display 150 may be selected based on, for example, a touch input, and the electronic device 101 may apply an effect to the selected first page (e.g., page 701) to indicate that the page has been selected. In response to a user input (e.g., an input detected through the input/output interface 140 and/or the touch screen of the display 150) for moving the selected first page (e.g., page 701) to page 705, the electronic device 101 may display the first page (e.g., page 701) in such a manner that the first page overlaps with page 705. The user input may be, for example, dragging the selected first page to page 705. The electronic device 101 may select page 705 as the second page when the first page overlaps with page 705.

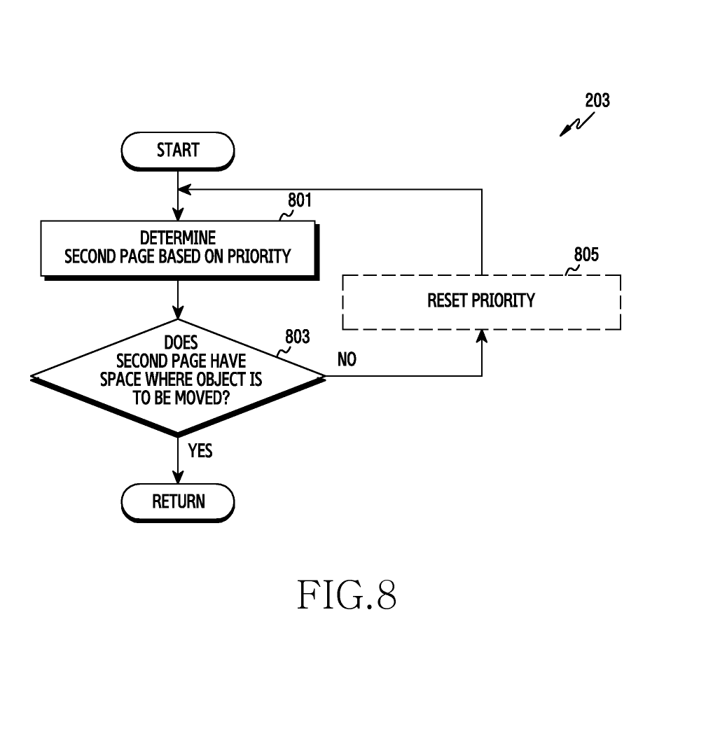

FIG. 8 is a flowchart illustrating an operation of determining a page to move an object based on a priority in the electronic device, according to various embodiments of the present disclosure.

Referring to operation 801, based on priority information for one or more pages, the electronic device 101 may select the second page to move objects (e.g., icons) to where the objects are in the first page, and the first page has been selected to be deleted. The priority information for the pages may be stored in the memory 130 of the electronic device 101, and may be organized as a database that is stored in the memory 130. Furthermore, the database may be stored in setting information that can be used to control at least one function of the electronic device 101, and the setting information may also be stored in the form of a table or a sheet.

According to an embodiment, the electronic device 101 may select at least one second page, other than the first page to be deleted, from the pages configured to be displayed on the display 150. When selecting the second page, the electronic device 101 may select a high priority page with reference to the priorities of the pages therein (e.g., the priorities for moving icons). In cases where the electronic device 101 detects an input for deleting the selected first page, the electronic device 101 may look at the priorities of the pages configured to be displayed on the display 150 to select the highest priority page (e.g., page 503) as the second page.

According to another embodiment, when selecting the second page, the electronic device 101 may select at least one of the pages that have lower priorities (or higher priorities) than the first page that has been selected to be deleted, based on the priorities that have been set for the pages of the electronic device 101. Referring to FIG. 4, when selecting page 403 to be deleted based on a user input, the electronic device 101 may select as the second page from the pages configured to be displayed on the display 150 at least one page (e.g., page 401 or 407) that has a lower priority than page 403.

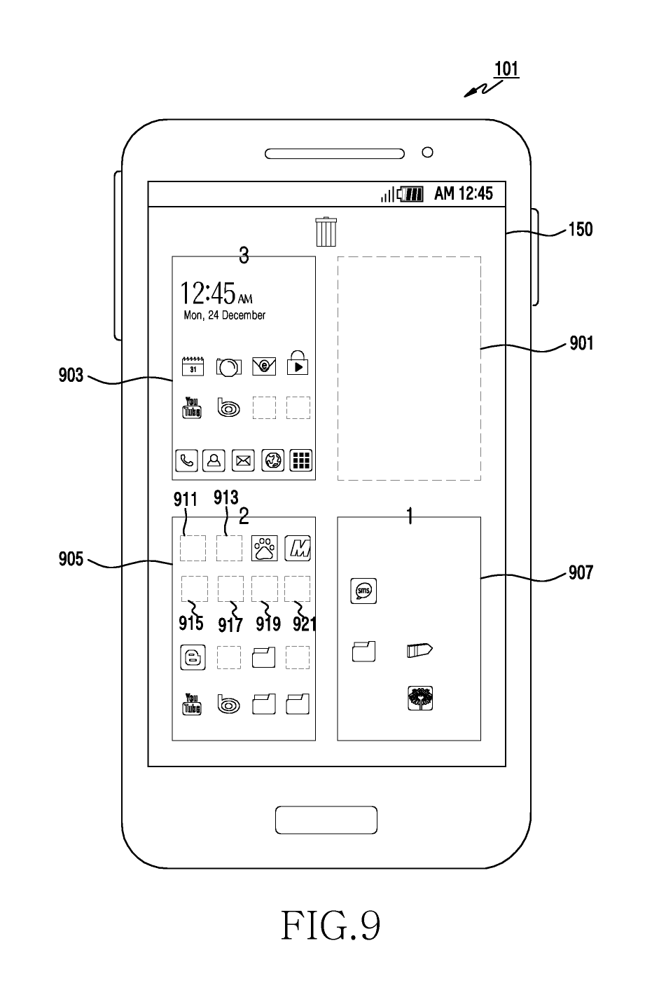

According to another embodiment, when selecting at least one second page, the electronic device 101 may select the second page based on the priorities of the pages depending on available spaces where icons can be moved. According to an embodiment, the electronic device 101 may identify the number of available spaces where icons can be moved in the pages that have been specified to be displayed on the display 150. Referring to FIG. 9, it can be identified that page 903 has two available spaces wherein icons can be moved, and page 905 has eight available spaces where icons can be moved. Accordingly, page 905 will be selected since it has more space available for icons. As described above, the electronic device 101 may select at least one second page based on the priorities that have been specified according to the conditions, such as the number of available spaces and/or whether the icons included in the first page can all be moved.

Referring to operation 803, the electronic device 101 may identify whether the second page has space for the icons of the first page. According to an embodiment, after moving one icon, the electronic device 101 may determine whether another icon can be moved to the second page. According to an embodiment, before performing the operation 205 of FIG. 2 (e.g., before moving the icons included in the first page to the second page), the electronic device 101 may determine whether an icon can be moved to the second page. When the second page has space where an icon can be moved, the electronic device 101 may end the process shown in FIG. 8, and when the second page has no space where an icon can be moved, the electronic device 101 may perform the operation 801 to select another page to which the icons included in the first page can be moved.

According to the above-described embodiment, although the electronic device 101 is illustrated as determining in advance whether an icon can be moved to the second page when the electronic device selects the second page, the electronic device 101, without being limited thereto, may move a predetermined number of icons from the first page to the second page and may then determine whether the same number of additional icons can be moved to the second page. According to an embodiment, the electronic device 101 may move two or more icons through the operation 205 of FIG. 2 and may then determine whether the same number of additional icons can be moved. When the determination result shows that two or more icons cannot be moved, the electronic device 101 may reduce the number of icons to be moved and may determine whether the new number of icons can be moved. For example, after moving three icons from the first page to the second page, the electronic device 101 may determine whether three more icons can be moved. When the determination result shows that three icons cannot be moved, the electronic device 101 may determine whether two icons can be moved. When even two icons cannot be moved to the second page, the electronic device 101 may determine whether one icon can be moved. When it is determined that even one icon cannot be moved, the electronic device 101 may determine that no icon can be moved to the second page.

When the second page has space where an icon can be moved, the electronic device 101 may end the process shown in FIG. 8, and when the second page has no space where an icon can be moved, the electronic device 101 may perform operation 801 to select another page (e.g., the third page) to receive the icons in the first page. Namely, in cases where the second page is a full page that has no space for an icon to be displayed, the electronic device 101 may select the third page to move the remaining objects in the first page.

In cases where the determination result in operation 803 shows that the second page has no space where a specified icon can be moved, the electronic device 101 may also perform operation 801 after operation 805.

Referring to operation 805, the electronic device 101 may set the priorities for one or more pages included in a database based on the result obtained by performing operation 803. According to an embodiment, in operation 801, the electronic device 101 may determine the primary page (e.g., page 503 of FIG. 5), which is specified on the basis of the number of available spaces where an icon is to be moved, to be the second page. In cases where the electronic device 101 moves the icons included in the first page (e.g., page 501) to the second page (e.g., page 503), the electronic device 101 may determine that page 503 has no available space where an icon is to be moved after moving the icons 511 and 513 to page 503. The electronic device 101 may set the priority of page 505, which had a lower priority than page 503 that does not have an available space for an icon any more, to first priority.

As described above, when the electronic device 101 determines that the second page, which has been selected to receive the icons from the first page, does not have available space for an icon any more, the electronic device 101 may adjust the priorities of the pages before selecting another page (e.g., the third page) to receive the remaining icons included in the first page.

The electronic device 101 may select the third page by performing the operation 801 based on the result obtained by performing the operation 803. According to an embodiment, when the electronic device 101 identifies that the second page has no space where an icon is to be moved, the electronic device 101 may select at least one page (e.g., the third page), other than the first and second pages, from the plurality of pages that have been specified to be displayed on the display 150. When selecting the third page from the remaining pages other than the first and second pages, the electronic device 101 may make the determination on the basis of the priorities that have been set for the pages based on the database, the attribute information of the pages, and/or the attribute information of objects included in the pages.

According to an embodiment, in cases where the priority information included in the database is adjusted by performing the operation 805, the electronic device 101 may also determine the third page based on the new priorities of the pages.

According to another embodiment, the electronic device 101 may select the third page based on a user input, without being limited to the method of selecting the third page based on the priorities as described in operation 801. For example, in cases where the second page has no space where an icon can be moved, the electronic device 101 may perform a notification operation through the display 150 or at least one other output device (e.g., a speaker or a motor, not illustrated), and may detect a user input for selecting at least one third page through the input/output interface 140 and/or the touch screen of the display 150.

According to various embodiments, the electronic device 101 may perform at least one of the operations 801, 803, and 805 of FIG. 8 as a sub-routine for the operation 203 of FIG. 2. In cases where the electronic device 101 performs the operations of FIG. 8 as a sub-routine for operation 203 of FIG. 2, the electronic device 101 may perform operation 801 after operation 201 of FIG. 2 and may perform operation 205 when the second page has space where a specified object is to be moved after the operation 803 is performed.

FIG. 9 illustrates the priorities assigned to pages in the electronic device, according to various embodiments of the present disclosure.

The electronic device 101 may determine the priorities of the pages that are currently displayed on the display 150 based on a database. According to an embodiment, the electronic device 101 may identify the priorities of the pages that have been configured to be displayed on the display 150 based on the database. For example, the electronic device 101 may determine the priorities of the pages on the number of available spaces of the pages. When determining the priorities of pages 901, 903, 905, and 907, the electronic device 101 may identify the available spaces of the remaining pages other than the first page (e.g., page 901) that is selected to be deleted, and may determine that page 907 with 12 available spaces is the first priority page, that page 905 having 8 available spaces is the second priority page, and page 903 having 2 available spaces is the third priority page. The electronic device 101 may determine page 907, which has the greatest number of available spaces, to be the second page to which the icons from the first page are to be moved.

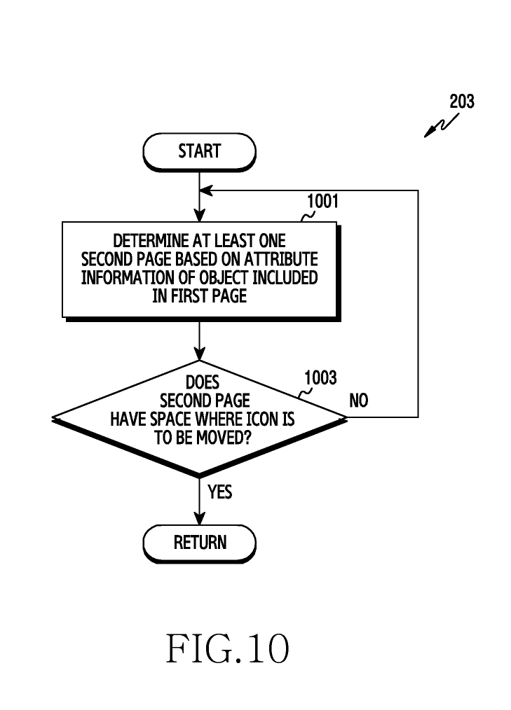

FIG. 10 is a flowchart illustrating an operation of determining a page to move an object based on attribute information in the electronic device, according to various embodiments of the present disclosure.

Referring to operation 1001, the electronic device 101 may select the second page to receive objects (e.g., icons) from the first page that has been selected to be deleted, based on attribute information of the icons included in the first page, priority information for one or more pages, and/or attribute information of icons included in the pages.

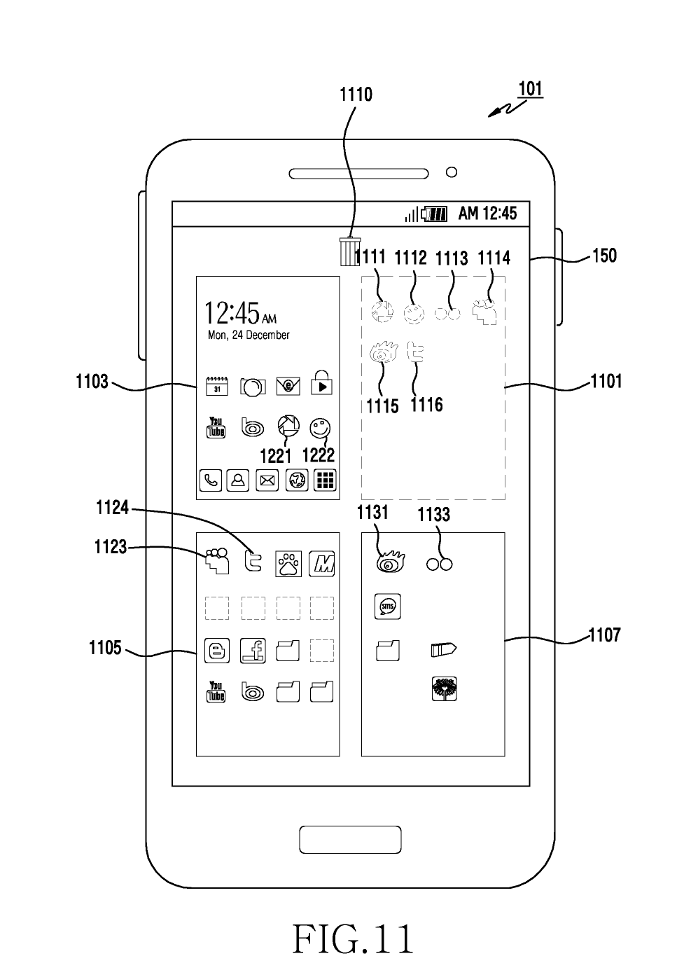

According to an embodiment, the electronic device 101 may identify the attribute information of the icons included in the first page. According to an embodiment, the electronic device 101 may select page 1101 as the first page as illustrated in FIG. 11 and which is to be deleted. The electronic device 101 may identify the attribute information of at least one of the icons (e.g., icons 1111, 1112, 1113, 1114, 1115, and 1116) that are included in the selected page 1101. According to an embodiment, the electronic device 101 may identify the attribute information of the icons based on categories of the programs (or applications) related to the icons. For example, the electronic device 101 may receive programs from on-line stores through various networks, such as, for example, the Internet. The electronic device 101 may determine the categories of the programs, which are stored in the on-line stores, to be the attribute information of the icons. Furthermore, when determining the attribute information of the icons, the electronic device 101 may determine the categories of the programs designated to the icons based on a user input.

The electronic device 101 may select at least one other page (e.g., a target page or a second page) based on the attribute information of the icons included in the first page (e.g., page 1101). According to an embodiment, the electronic device 101 may determine that the number of icons that include Internet related attribute information is highest among the icons included in the first page (e.g., page 1101). The electronic device 101 may identify attribute information of other pages or attribute information of icons included in the other pages. The electronic device 101 may determine the priorities of the pages that include icons corresponding to Internet attribute information based on the attribute information of the pages.

For example, the electronic device 101 may determine the attributes of the icons 1111, 1112, and 1113 to be the Internet, the attributes of the icons 1114 and 1116 to be social networks, and the attribute of the icon 1115 to be none. In regard to the attributes of the icons included in the first page, the electronic device 101 may determine pages that have the same or similar attributes. According to an embodiment, the electronic device 101 may determine that page 1103 has the greatest number of icons having Internet attributes and page 1105 has the greatest number of icons having social network attributes, based on the attribute information of the icons included in the respective pages. The electronic device 101 may determine to move the icons 1111, 1112, and 1113, which have Internet attributes, to page 1103 that has the greatest number of icons having Internet attributes, and to move the icons 1114 and 1116, which have social network attributes, to page 1105 that has the greatest number of icons having social network attributes. The electronic device 101 may determine to move the icon 1115, which has no attribute, to a page 1107 that has the greatest number of available spaces where icons are to be moved.

According to various embodiments, based on the attribute information of the icons included in the first page (e.g., page 1101), the electronic device 101 may select pages that include icons with similar corresponding attribute information. According to an embodiment, the electronic device 101 may identify the attribute information of the icons included in the first page to be the Internet and games. The electronic device 101 may determine to move the icons to a page that includes an icon corresponding to the attribute information of the Internet and/or a page that includes an icon corresponding to a game among the pages designated to be displayed on the display 150.

Referring to operation 1003, the electronic device 101 may identify whether the second page has space where the icons of the first page are to be moved (or whether the icons included in the first page can be moved to the second page). According to an embodiment, after moving one icon, the electronic device 101 may determine whether another icon can be moved to the second page. According to an embodiment, before performing the operation 205 of FIG. 2 (e.g., before moving the icons included in the first page to the second page), the electronic device 101 may determine whether an icon can be moved to the second page. When the second page has space where an icon can be moved, the electronic device 101 may end the process shown in FIG. 8, and when the second page has no space where an icon can be moved, the electronic device 101 may perform operation 801 to select another page where the icons from the first page can be moved.

According to the above-described embodiment, although the electronic device 101 is illustrated as determining in advance whether an icon can be moved to the second page when the electronic device selects the second page, the electronic device 101, without being limited thereto, may move a predetermined number of icons from the first page to the second page and may then determine whether the same number of icons can be moved to the second page. According to an embodiment, the electronic device 101 may move two or more icons through the operation 205 of FIG. 2 and may then determine whether the same number of icons can be moved again. When the determination result shows that two or more icons cannot be moved, the electronic device 101 may reduce the number of icons to be moved and may determine whether the new number of icons can be moved. For example, after moving three icons from the first page to the second page, the electronic device 101 may determine whether three more icons can be moved. When the determination result shows that three icons cannot be moved, the electronic device 101 may determine whether two more icons can be moved. When the determination result shows that two icons cannot be moved to the second page, the electronic device 101 may determine whether one icon can be moved, and when it is determined that one icon cannot be moved, the electronic device 101 may determine that an icon can no longer be moved to the second page.

When the second page has space where an icon can be moved, the electronic device 101 may end the process shown in FIG. 10, and when the second page has no space where an icon can be moved, the electronic device 101 may perform operation 1001 to select another page (e.g., the third page) where the icons from the first page can be moved.

When the determination result in operation 1003 shows that the second page has no available space where an icon can be moved, the electronic device 101 may determine the third page based on attribute information (e.g., may determine the third page by repeatedly performing the operation 1001). According to an embodiment, when the electronic device 101 determines that the icons 1111 and 1113 having Internet attributes should move to page 1103, the electronic device 101 may find that page 1103 has no available space for an icon. Based on the attribute information of the icons included in the respective pages, the electronic device 101 may determine to move the icon 1113 to a page (e.g., page 1107) that has the second greatest number of icons relating to the Internet.

When the determination result in operation 1003 shows that the second page has available space where an icon can be moved, the electronic device 101 may end the process shown in FIG. 10.

According to various embodiments, the electronic device 101 may perform at least one of the operations 1001 and 1003 of FIG. 10 as a sub-routine for operation 203 of FIG. 2. In cases where the electronic device 101 performs the operations of FIG. 10 as a sub-routine for operation 203 of FIG. 2, the electronic device 101 may perform operation 1001 after operation 201 of FIG. 2 and may perform operation 205 after operation 1003.

FIG. 11 illustrates an operation of moving an object in the electronic device, according to various embodiments of the present disclosure.

According to various embodiments, when the electronic device 101 moves icons included in the first page to the second page based on attribute information, the electronic device 101 may identify a case in which an icon cannot be moved to the specified page (e.g., when there is no available space). The electronic device 101 may determine to move the corresponding icon to another page (e.g., a third page). According to an embodiment, in cases where the electronic device 101 cannot move an icon (e.g., icon 1113) in the first page having an Internet attribute to a page (e.g., page 1103) that has the greatest number of icons having the Internet attribute, the electronic device 101 may determine to make the icon move to a page (e.g., page 1107) that has the second greatest number of icons relating to the Internet.

According to another embodiment, in cases where the electronic device 101 cannot move an icon (e.g., icon 1113) in the first page having an Internet attribute to a page (e.g., page 1103) that has the greatest number of icons having Internet attributes, the electronic device 101 may ignore the attribute of the icon and may determine to move the icon to a page (e.g., page 1107) with the most available space.

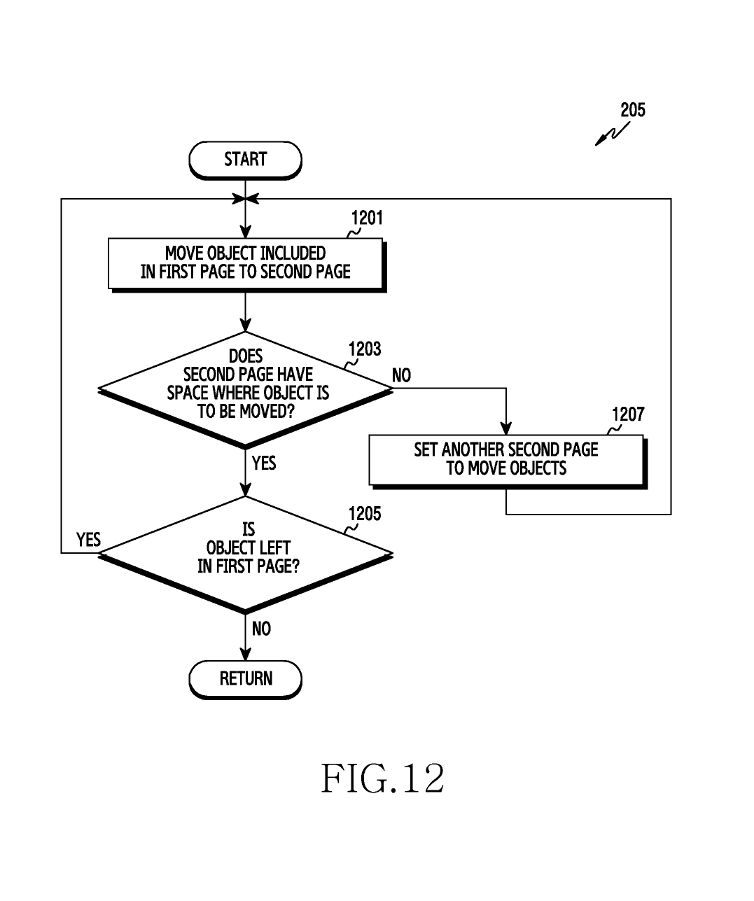

FIG. 12 is a flowchart illustrating an operation of moving an object to a page in the electronic device, according to various embodiments of the present disclosure.

Referring to operation 1201, the electronic device 101 may move icons included in the selected first page to a target page (e.g., the second page). When performing operation 1201, the electronic device 101 may perform an operation to detect an input for selecting and deleting the first page and moving an icon to the second page as illustrated in FIG. 3, or an operation to detect an input for selecting and moving the first page with its icon(s) to the second page as illustrated in FIG. 7.

Referring to operation 1203, the electronic device 101 may identify whether the second page has space to receive the icons of the first page (or whether the icons included in the first page may be moved to the second page). According to an embodiment, after moving one icon, the electronic device 101 may determine whether another icon can be moved to the second page. Alternatively, after moving two or more icons, the electronic device 101 may determine whether the same number of icons can be moved. When the determination result shows that two or more icons cannot be additionally moved, the electronic device 101 may reduce the number of icons to be moved and may determine whether the icons can be moved. For example, after moving three icons included in the first page to the second page, the electronic device 101 may determine whether three more icons can be moved. When the determination result shows that three icons cannot be moved, the electronic device 101 may determine whether two more icons can be moved. In addition, when the determination result shows that two icons cannot be moved to the second page, the electronic device 101 may determine whether one icon can be moved, and when it is determined that one icon cannot be moved, the electronic device 101 may determine that an icon can no longer be moved to the second page.

According to the above-described embodiment, although the electronic device 101 is illustrated as moving a predetermined number of icons from the first page to the second page and then determining whether the same number of icons can be moved to the second page, the electronic device 101, without being limited thereto, may determine in advance whether an icon can be moved to the second page when determining an input for moving a predetermined number of icons from the first page to the second page. According to an embodiment, before performing operation 1207 (e.g., before moving the icons included in the first page to the second page), the electronic device 101 may determine whether an icon can be moved to the second page. The electronic device 101 may perform operation 1205 when the second page has space where an icon can be moved and may perform operation 1207 when the second page has no space where an icon can be moved.

Referring to operation 1205, the electronic device 101 may identify whether an icon exists in the first page. For example, the electronic device 101 may perform operation 1201 when there is at least one icon that can be moved from the first page to the second page, or may end the process shown in FIG. 12 when there is no icon in the first page.

Referring to operation 1207, the electronic device 101 may select at least one other second page to receive the icons from the first page, where the first page has been selected to be deleted. When the electronic device 101 selects at least one other second page, the electronic device 101 may select at least one page, which is different from the preset second page, as the second page based on page information included in a database. According to an embodiment, the electronic device 101 may select the second page based on the priorities set for the respective pages, or based on at least one of attribute information of the icons included in the first page (or attribute information of programs relating to the icons), attribute information of pages that are configured to be displayed on the display 150, and/or attribute information of icons included in the pages that are configured to be displayed on the display 150. When the determination result in operation 1203 shows that the previously selected second page has no available space, the electronic device 101 may select another second page to receive the icons included in the first page from the remaining pages other than the previously selected second page. The electronic device 101 may perform the operation 1201 after the operation 1207.

According to various embodiments, the electronic device 101 may perform at least one of the operations 1201, 1203, 1205, and 1207 of FIG. 12 as a sub-routine for the operation 205 of FIG. 2. In cases where the electronic device 101 performs the operations of FIG. 12 as a sub-routine for operation 205 of FIG. 2, the electronic device 101 may perform operation 1201 after operation 207 of FIG. 2 and may perform operation 207 after operation 1205.

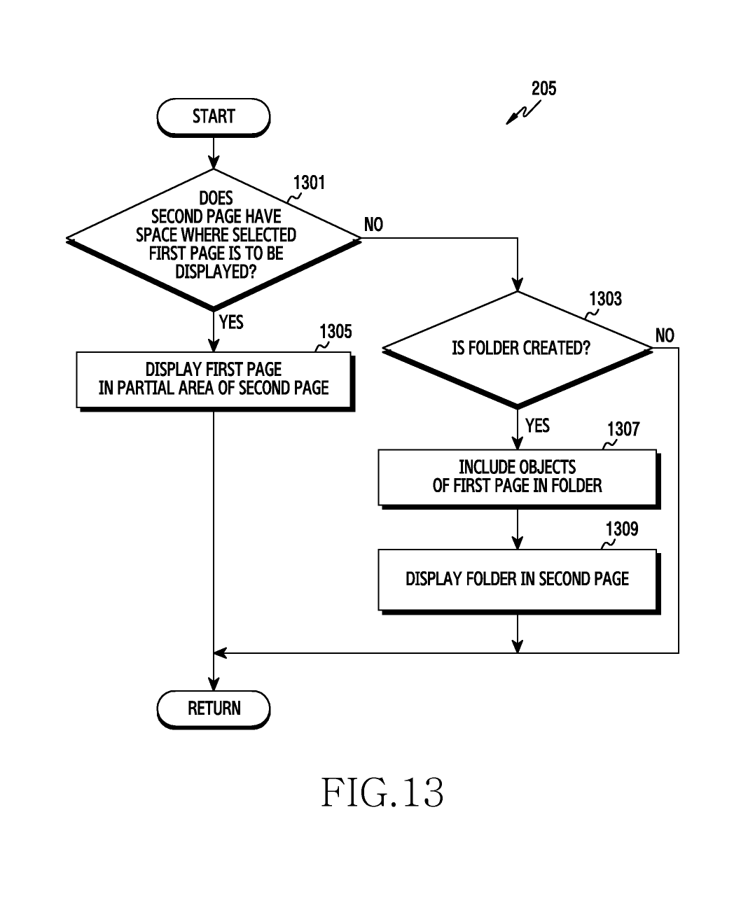

FIG. 13 is a flowchart illustrating an operation of moving an object included in a page in the electronic device, according to various embodiments of the present disclosure.

Referring to operation 1301, the electronic device 101 may determine whether the second page has space in which the first page can be displayed. According to an embodiment, when displaying the first page in another page, the electronic device 101 may change (e.g., reduce) the size of the first page to be an image in the form of a thumbnail (or a thumbnail image) in the second page. The electronic device 101, when displaying the first page to be an image in the form of a thumbnail in the second page, may require an area that has the shape of a rectangle where four icons are arranged (e.g., referring to FIG. 3, the areas 311, 313, 315, and 317 of page 305). The electronic device 101 may perform operation 1305 when it is determined that the second page has space in which the first page can be displayed, and may perform operation 1303 when it is determined that the second page has no space to display the first page.

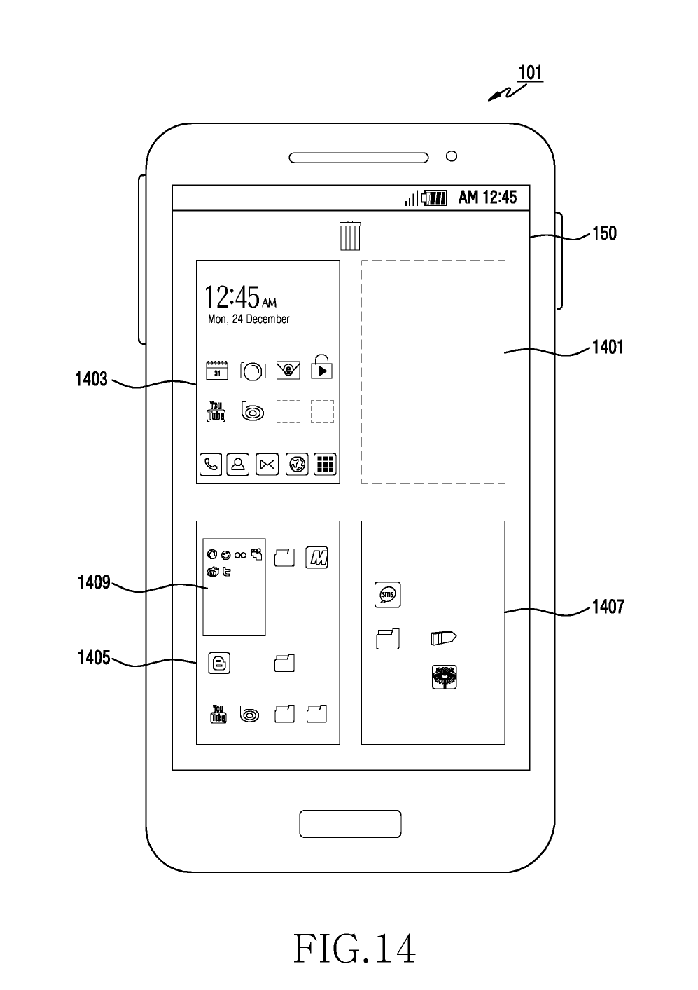

Referring to operation 1305, the electronic device 101 may display the first page in a partial area of the second page. According to an embodiment, the electronic device 101 may change the size of the first page when displaying the first page in the second page. For example, the electronic device 101 may change the first page into a rectangular image in which a predetermined number (e.g., four) of icons are arranged. The electronic device 101 may display the first page 1401, the size of which has been reduced, in a partial area of the second page (e.g., page 1405 of FIG. 14) as page 1409 of FIG. 14. According to various embodiments, when the first page (e.g., page 1409) to be displayed on page 1405 is selected, the electronic device 101 may display a magnified image of page 1409 on the display 150, or may add a new page specified to be displayed on the display 150.

Referring to operation 1303, when the determination result in operation 1301 shows that the second page has no space where a thumbnail image of the first page can be displayed, the electronic device 101 may output a message to confirm whether to move to the second page a folder that includes the icons of the first page. The electronic device 101 may identify a response to the notification output through the input/output interface 140 and/or the touch screen of the display 150. The electronic device 101 may perform operation 1307 when an input to create the folder is detected, and may end the process shown in FIG. 13 when an input to not create the folder is detected.

Referring to operation 1307, the electronic device 101 may include the icons of the first page in at least one folder. According to an embodiment, the electronic device 101 may create one folder and may include the icons of the first page in the created folder.

According to various embodiments, the electronic device 101 may identify the attribute information of the icons included in the first page. Based on the attribute information of the icons included in the first page, the electronic device 101 may include the icons having the same or similar attribute information in an identical folder.

Referring to operation 1309, the electronic device 101 may display the folder, which includes at least one icon, in the second page. According to an embodiment, the electronic device 101 may display the folder (e.g., a folder 1509 of FIG. 15), which has been created in operation 1307, in the second page (e.g., a page 1505). The electronic device 101 may display the folder in the second page according to the size assigned to the folder. For example, when determining the size of the folder to be the same as that of an icon, the electronic device 101 may display the folder (e.g., folder 1509) at a location 1511 of FIG. 15.

The electronic device 101 may end the process shown in FIG. 13 after performing operation 1309.

According to various embodiments, the electronic device 101 may perform at least one of the operations 1301, 1303, 1305, 1307, and 1309 of FIG. 13 as a sub-routine for operation 205 of FIG. 2. In cases where the electronic device 101 performs the operations of FIG. 13 as a sub-routine for operation 205 of FIG. 2, the electronic device 101 may perform operation 1301 after operation 203 of FIG. 2 and may perform operation 207 after operation 1303, 1305, or 1309.

FIG. 14 illustrates an operation of displaying a page on another page in the electronic device, according to various embodiments of the present disclosure.

According to various embodiments, the electronic device 101 may detect a user input for selecting at least one of the pages displayed on the display 150 (e.g., page 301 of FIG. 3) and moving the selected page to the second page (e.g., page 305 of FIG. 3). The electronic device 101 may determine whether the second page has space where the selected first page can be displayed, and when it is determined that the second page has space, the electronic device 101 may display the first page in a partial area of the second page. For example, the electronic device 101, when displaying the first page in the second page, may change the size of the first page. According to an embodiment, the electronic device 101 may display the first page, the size of which has been changed, in such a manner of displaying one icon in a plurality of icon areas (e.g., in a rectangular area, such as areas 311, 313, 315, and 317 of FIG. 3). According to an embodiment, the electronic device 101 may display the first page (e.g., page 301 of FIG. 3), in the second page (e.g., page 305) much as page 1409 is shown in page 1405. According to an embodiment, page 1409 displayed on the display 150 may function as a folder.

According to various embodiments, while selecting and moving the first page (e.g., page 701), the electronic device 101 may move the icons (e.g., icon 711, icon 713, icon 714, icon 717, icon 719, and/or icon 721) displayed in the selected first page (e.g., page 709) together with the first page (e.g., page 709), maintaining the arrangement of the icons.

FIG. 15 illustrates an operation of displaying a page on another page in the electronic device, according to various embodiments of the present disclosure.

According to various embodiments, the electronic device 101 may detect a user input for selecting at least one of the pages displayed on the display 150 (e.g., page 301 of FIG. 3) and moving the selected page to the second page (e.g., page 305 of FIG. 3). The electronic device 101 may determine whether the second page has space (e.g., a rectangular area constituted by four icons, like page 305 of FIG. 3) where the first page can be displayed. When it is determined that the second page has no space where the first page can be displayed, the electronic device 101 may include the icons of the first page in at least one folder. The electronic device 101, when including the icons of the first page in the folder, may perform the same or a similar operation to that performed in operation 1307. For example, the electronic device 101 may identify the attribute information of the icons included in the first page and may include the icons in at least one folder such that the icons are distinguished from each other based on their attribute information.

According to various embodiments, the electronic device 101 may display the at least one folder, which includes icons, in the second page (e.g., page 1505) displayed on the display 150. According to an embodiment, when displaying the folder in page 1505 the electronic device 101 may display the folder at a location (e.g., location 1511) corresponding to a size that is specified for the display of the folder. For example, when the electronic device 101 displays the folder in pages designated to be displayed on the display 150, the size of the folder may be the same as that of an icon. Alternatively, when the electronic device 101 displays the folder in pages designated to be displayed on the display 150, the electronic device 101 may make different determinations according to the respective pages based on setting information. For example, the electronic device 101 may make different determinations of sizes according to the respective pages based on setting information.

According to various embodiments, displaying the folder, which includes the icons of the first page (e.g., page 301 of FIG. 3), in the second page (e.g., page 1505) may be based on the setting information in the electronic device 101 or a user input into the electronic device 101.

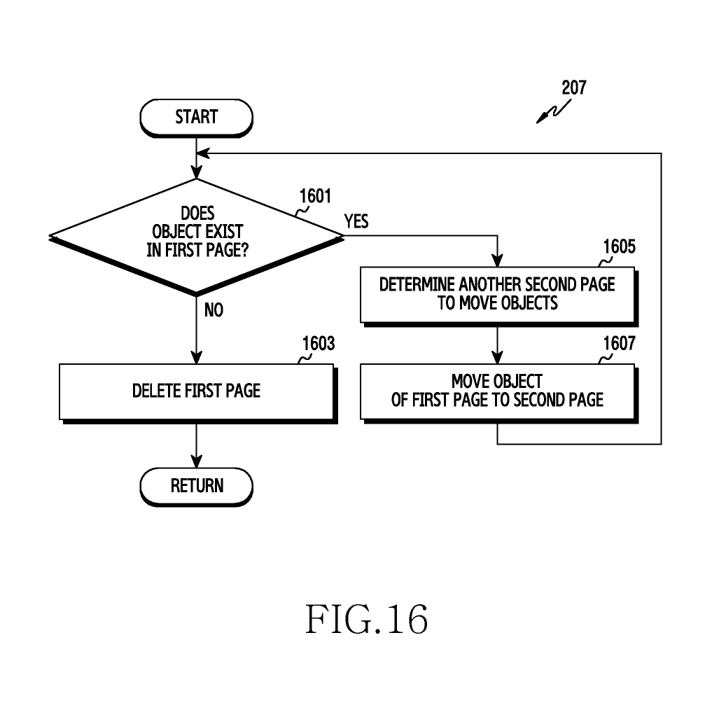

FIG. 16 is a flowchart illustrating an operation of deleting a page in the electronic device, according to various embodiments of the present disclosure.

Referring to operation 1601, the electronic device 101 may identify whether an icon exists in the first page. For example, the electronic device 101 may perform operation 1605 when there is at least one icon that can be moved from the first page to the second page, or may perform operation 1603 when there is no icon in the first page.

Referring to operation 1603, the electronic device 101 may delete the first page when it is determined that no icon exist in the first page. The electronic device 101 may end the process shown in FIG. 16 after performing operation 1603.

Referring to operation 1605, the electronic device 101 may select at least one other page to receive the icons included in the first page, where the first page has been selected to be deleted. The electronic device 101 may select at least one other page, which is different from the preset second page, as the second page based on page information included in a database. According to an embodiment, when the electronic device 101 selects the second page, the electronic device 101 may select the second page based on the priorities set for the respective pages, or based on at least one of attribute information of the icons included in the first page (or attribute information of programs relating to the icons), attribute information of pages that are configured to be displayed on the display 150, and/or attribute information of icons included in the pages that are configured to be displayed on the display 150. When the determination result in operation 1203 shows that the previously selected second page has no available space, the electronic device 101 may select other page to receive the icons included in the first page, based on the remaining pages other than the previously selected second page.

Referring to operation 1607, the electronic device 101 may move to the second page at least one object (e.g., icon) that is included in the first page (e.g., page 1501). For example, the operation of moving an icon included in the first page to the second page may include an operation of selecting at least one second page and an operation of moving the icon included in the first page to the selected second page. The electronic device 101 may move icons displayed in the first page to the second page to display the icons in the second page, may move the first page to the second page to display the first page in a partial area of the second page, and/or may move a folder that includes the icons of the first page to the second page to display the folder in the second page. The electronic device 101 may perform the operation 1601 after the operation 1607.

According to various embodiments, the electronic device 101 may perform at least one of the operations 1601, 1603, 1605, and 1607 of FIG. 16 as a sub-routine for operation 207 of FIG. 2. In cases where the electronic device 101 performs the operations of FIG. 16 as a sub-routine for operation 207 of FIG. 2, the electronic device 101 may perform operation 1601 after operation 205 of FIG. 2 and may end the process shown in FIG. 2 after operation 1603.

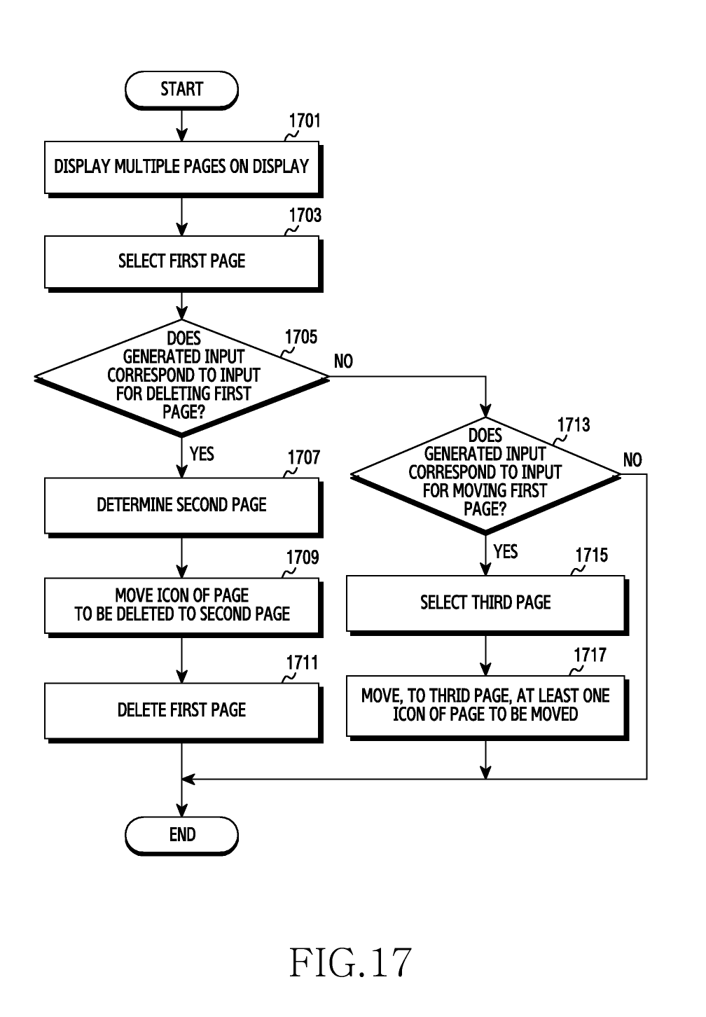

FIG. 17 is a flowchart illustrating an operation of processing a plurality of pages in an electronic device, according to various embodiments of the present disclosure.

Referring to operation 1701, the electronic device 101 may display a plurality of pages on the display 150. According to an embodiment, the electronic device 101 may display, on the display 150, a plurality of pages that include at least one user interface (e.g., icon). Referring to FIG. 3, the electronic device 101 may display page 301, page 303, page 305, and page 307 on the display 150. Herein, each page may include at least one user interface (e.g., icon). Referring to FIG. 3, although the electronic device 101 displays the four pages 301, 303, 305, and 307 on the display 150, in cases where an additional page is configured, the electronic device 101, without being limited thereto, may additionally display the corresponding page (not illustrated) on a window of the display 150, or may move to a different window to display the additional page (not illustrated). In the following description, pages configured to be displayed on the display 150 may include a plurality of pages that are displayed on the display 150 of the electronic device 101 and/or pages that are not displayed on the display 150.

Referring to operation 1703, the electronic device 101 may select at least one (e.g., the first page) of the plurality of pages displayed on the display 150. According to an embodiment, in a method of selecting a page, when a user input as touching the first page among the plurality of pages displayed on the display 150 is detected, the electronic device 101 may select the page detected as the first page. For example, referring to FIG. 7, the electronic device 101 may select page 701 based on a user input that is performed through user's touch. Herein, among various touch inputs, such as a single tap, a double tap, and a touch that is maintained for a specified period of time, at least one stored in the setting information may be used for the method of selecting a page based on a touch.

Referring to operation 1705, the electronic device 101 may determine whether the generated user input corresponds to an input for deleting the selected first page. According to an embodiment, the electronic device 101 may detect an operation of selecting at least one first page among the plurality of pages displayed on the display 150 and selecting a deletion icon displayed on the display 150. For example, referring to FIG. 3, the electronic device 101 may detect an input for selecting a recycling bin icon 310 after selecting page 301 as the first page.

Herein, in the method of selecting at least one first page (e.g., page 301) and selecting a recycle bin (e.g., the recycling bin icon 310), the electronic device 101 may detect a user input for touching page 301 displayed on the display 150, dragging the page 301 to the recycling bin icon 310, and dropping the page 301 at the recycle bin. Alternatively, the electronic device 101 may detect a user input for selecting page 301 by touching page 301 displayed on the display 150, followed by detecting that specified time (e.g., 1 second) has elapsed while the touch is maintained, and then touching the recycling bin icon 310. In another case, the electronic device 101 may detect a user input for selecting page 301 by touching the check box that corresponds to page 301 displayed on the display 150, and then touching the recycling bin icon 310. As described above, the electronic device 101 may perform operation 1707 to detect the input for deleting the selected first page and may perform operation 1711 to detect another input rather than the input for deleting the selected first page.

Referring to operation 1707, the electronic device 101 may select at least one target page (e.g., the second page) from the plurality of pages that are displayed (and/or not displayed) on the display 150. When selecting at least one second page, the electronic device 101 may select a high priority page with reference to the priorities of the pages therein (e.g., the priorities for moving icons). Referring to FIG. 3, in cases where the electronic device 101 detects the input for deleting the selected first page, the electronic device 101 may identify the priorities of the pages configured to be displayed on the display 150 and may select the highest priority page (e.g., page 303) as the second page from the rest of the pages other than the selected first page.

According to another embodiment, when selecting at least one second page, the electronic device 101 may select at least one of the pages that have lower priorities (or higher priorities) than the first page that has been selected to be deleted, based on the priorities that have been set for the pages of the electronic device 101. Referring to FIG. 3, when selecting page 303 based on a user input to delete the same, the electronic device 101 may select at least one page (e.g., page 301 or 307) that has a lower priority than page 303, as the second page, from the pages configured to be displayed on the display 150 thereof.

According to another embodiment, when selecting at least one second page, the electronic device 101 may select the second page based on available spaces of the pages where icons can be moved. According to an embodiment, the electronic device 101 may identify the number of available spaces where icons can be moved in the pages that have been specified to be displayed on the display 150. Referring to FIG. 3, it can be identified that page 303 has two available spaces wherein icons can be moved, and page 305 has eight available spaces where icons can be moved. Accordingly, page 305 may have a higher priority than page 303. As described above, the electronic device 101 may select at least one second page according to the descending or ascending order of the available spaces of the pages.

Referring to operation 1709, the electronic device 101 may move the icon displayed in the first page to the selected second page. For example, referring to FIG. 7, when the electronic device 101 detects a user input for deleting page 701, the electronic device 101 may move page 701 (or at least one icon included in the selected page 701) to at least one second page (e.g., page 703 selected through operation 1707).

Referring to operation 1711, the electronic device 101 may delete the first page after moving the icon included in the first page to the second page. According to an embodiment, the electronic device 101 may move the first page or the icon included in the first page to at least one target page (e.g., the second page) based on a deletion input generated in the selected first page, and may delete the first page when identifying that the first page includes no icon.

The electronic device 101 may end the process shown in FIG. 2 after performing operation 1711.

Referring to operation 1713, the electronic device 101 may select the first page and may identify whether the generated input correspond to an input for moving the first page. According to an embodiment, when identifying that the generated input corresponds to an input for selecting and moving the first page, the electronic device 101 may determine the input to be an input for moving the first page. For example, when identifying an input for moving the first page, the electronic device 101 may determine the generated input to be an input for moving the first page in cases where the first page is dragged.

Referring to operation 1715, the electronic device 101 may select a target page (e.g., the third page). Herein, the third page selected in operation 1715 may be the same as the second page. According to an embodiment, the electronic device 101 may select the third page through the same or a similar method to the operation of selecting the third page in the operation 1707.

According to an embodiment, when selecting the third page, the electronic device 101 may detect an input for touching the first page selected from the pages displayed on the display 150 and dragging the first page. The electronic device 101 may detect a drag input for controlling the selected first page to overlap with another page with a specified overlapping area therebetween. When detecting a release input while the selected first page overlaps with the other page with a specified overlapping area therebetween, the electronic device 101 may determine the corresponding page to be the third page.

Referring to operation 1717, the electronic device 101 may move at least one of the user interfaces (e.g., icons) included in the selected first page to the third page. According to an embodiment, the electronic device 101 may use the same or a similar method to that performed in operation 1709 when moving at least one icon included in the selected first page to the third page.

The electronic device 101 may end the process shown in FIG. 17 after performing operation 1717.

According to the above-described embodiment of FIG. 17, although the electronic device 101 is illustrated as selecting a single page (e.g., page 301) to be the first page, the electronic device 101 may also select two or more pages to be the first pages. According to an embodiment, when the electronic device 101 selects page 301 and at least one other page and selects the second page or the recycling bin icon 310, the electronic device 101 may move, to the second page, the icons that are included in page 301 and at least one other selected page. In addition, when page 301 and/or at least one other selected page include no icon, the electronic device 101 may delete the corresponding page.

According to various embodiments, the electronic device 101 may perform at least one of the operations of FIG. 17 as a sub-routine for the operation 205 of FIG. 2. In cases where the electronic device 101 performs the operations of FIG. 17 as a sub-routine for operation 205 of FIG. 2, operation 1701 may be an operation to be performed after operation 205 of FIG. 2, and the electronic device 101 may perform operation 207 after operation 205.

According to various embodiments, a method of operating an electronic device may include: displaying a plurality of pages that include icons on a display; selecting first and second page from the plurality of pages displayed on the display; moving the icons included in the first page to the second page to arrange the icons in the second page; and displaying the arranged icons in the second page. According to an embodiment, the method may further include deleting the first page. According to an embodiment, deleting the first page may be performed when the first page does not include any icon. According to an embodiment, selecting the first and second pages may include detecting an input for selecting the first page and deleting the first page. According to an embodiment, selecting the first and second pages may include detecting an input for selecting the first page and moving the first page to the second page. According to an embodiment, selecting the first and second pages may further include selecting the second page based on attribute information of the icons included in the first page. According to an embodiment, moving the icons included in the first page to the second page to arrange the icons in the second page may include disposing the first page in a partial area of the second page. According to an embodiment, moving the icons included in the first page to the second page to arrange the icons in the second page may further include: including the icons of the first page in a folder; and moving the folder to the second page to dispose the folder in the second page. According to an embodiment, including the icons of the first page in the folder may further include including the icons of the first page in two or more folders. According to an embodiment, moving the icons included in the first page to the second page to arrange the icons in the second page may further include: selecting a third page; and moving some of the icons included in the first page to the third page to arrange the same in the third page.

The various embodiments performed by the electronic device 101 may be operations performed under control of the processor 120. In addition, the electronic device 101 may include a separate module from the processor 120, which is programmed to control the various embodiments of the present disclosure. The separate module programmed to control the various embodiments of the present disclosure may operate under the control of the processor 120.

The processor 120 may perform a process to display a plurality of pages that include one or more icons on a display, and may perform a process to select first and second pages from the plurality of pages displayed on the display, to move the icons included in the first page to the second page and arrange the icons in the second page, and to display the arranged icons in the second page. According to an embodiment, the processor may delete the first page when the first page includes no icon. According to an embodiment, the processor may select the first and second pages based on an input for selecting the first page and deleting the first page. According to an embodiment, the processor may select the first page and may select the first and second pages based on an input for moving the first and second pages. According to an embodiment, the processor may select the second page based on attribute information of the icons included in the first page. According to an embodiment, the processor may dispose the first page in a partial area of the second page. According to an embodiment, the processor may include the icons of the first page in a folder and may move the folder to the second page to dispose the same in the second page. According to an embodiment, the processor may include the icons of the first page in two or more folders. According to an embodiment, the processor may select a third page and may move some of the icons included in the first page to the third page to arrange the icons in the third page.

Each of the above described elements of the electronic device according to various embodiments of the present disclosure may include one or more components, and the name of a corresponding element may vary according to the type of electronic device. The electronic device according to various embodiments of the present disclosure may include at least one of the above described elements and may exclude some of the elements or further include other additional elements. Furthermore, some of the elements of the electronic device according to various embodiments of the present disclosure may be coupled to form a single entity while performing the same functions as those of the corresponding elements before the coupling.

According to various embodiments, at least a part of the devices and methods, according to the various embodiments disclosed in the claims and/or the specification of the present disclosure, may refer to, or may be implemented by, a form (e.g., a module or unit) that includes hardware, software, firmware, or a combination of one or more thereof. The term “module” may be interchangeably used with the term, for example, “unit,” “logic,” “logical block,” “component,” “circuit,” or the like. The “module” may be a minimum unit of an integrated component element or a part thereof. The “module” may be the smallest unit that performs one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter. If implemented in software, a computer-readable storage medium (or storage medium readable by a computer) storing at least one program (or programming module) may be provided. The software may, for example, be implemented by instructions stored in a computer-readable storage medium in the form of a programming module. The at least one program may include instructions that cause the electronic device to perform the methods according to various embodiments of the present disclosure as defined by the appended claims and/or disclosed herein. When the command is executed by one or more processors (for example, the processor 120), the one or more processors may execute a function corresponding to the command. The computer-readable storage medium may, for example, be the memory 230. At least a part of the programming module may, for example, be implemented (e.g., executed) by the processor 220. At least a part of the programming module may, for example, include a module, a program, a routine, a set of instructions, or a process for performing at least one function.

The computer-readable storage medium may include magnetic media such as a hard disc, a floppy disc, and a magnetic tape; optical media such as a compact disc read only memory (CD-ROM) and a digital versatile disc (DVD); magneto-optical media such as a floptical disk; a hardware device specifically configured to store and execute program instructions (e.g., programming module), such as read only memory (ROM), random access memory (RAM), and flash memory; electrically erasable programmable read only memory (EEPROM); magnetic disc storage device; any other type of optical storage device; and magnetic cassette. Alternatively, any combination of some or all of the may form a memory in which the program is stored. Furthermore, a plurality of such memories may be included in the electronic device. In addition, the program instructions may include high class language codes, which can be executed in a computer by using an interpreter, as well as machine codes made by a compiler.

According to various embodiments, the electronic device 101 may include a computer readable storage medium having a program stored therein for performing: an operation of displaying a plurality of pages that include icons on a display; an operation of selecting first and second pages from the plurality of pages displayed on the display; an operation of moving the icons included in the first page to the second page and arranging the icons in the second page; and an operation of displaying the arranged icons in the second page.

According to various embodiments, the electronic device 101 may include a computer readable storage medium having a program stored therein for performing: an operation of selecting a first page to delete from a plurality of pages; an operation of selecting a second page, to which objects included in the first page are to be moved, from the plurality of pages; an operation of moving the objects included in the first page to a second page; and an operation of deleting the first page.

In addition, the program may be stored in an attachable storage device capable of accessing the electronic device through a communication network such as the Internet, an intranet, a local area network (LAN), a wide LAN (WLAN), a storage area network (SAN), or any combination thereof. The storage devices may be connected to an electronic device through an external port. Furthermore, a separate storage device on the communication network may access a portable electronic device. Any of the hardware devices as described above may be configured to work as one or more software modules in order to perform the operations according to various embodiments of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Furthermore, some operations may be executed according to another order or may be omitted, or other operations may be added.

The embodiments of the present disclosure disclosed herein and shown in the drawings are merely specific examples presented in order to easily describe technical details of the present disclosure and to help the understanding of the present disclosure, and are not intended to limit the scope of the present disclosure. Therefore, it should be construed that, in addition to the embodiments disclosed herein, all modifications and changes or modified and changed forms derived from the technical idea of the present disclosure fall within the scope of the present disclosure.

What is claimed is:

1. A method of operating an electronic device, comprising:
selecting a first page to delete from a plurality of pages;
selecting a second page, to which objects in the first page are to be moved, from the plurality of pages;
moving the objects to the second page; and
deleting the first page.

2. The method of claim 1, further comprising:
displaying the moved objects in the second page.

3. The method of claim 1, further comprising:
identifying whether any object remains in the first page; and
deleting the first page when the first page has no objects.

4. The method of claim 1, wherein selecting the second page comprises:
detecting a movement of an input for selecting the first page;
detecting a release of the input; and
selecting a page corresponding to a location of the released input as the second page.

5. The method of claim 1, wherein selecting the second page comprises:
identifying priorities assigned to the plurality of pages; and
selecting at least one page, as the second page, from the plurality of pages based on the identified priorities.

6. The method of claim 1, wherein selecting the second page comprises:
identifying attribute information of the objects; and
selecting at least one page, as the second page, from the plurality of pages based on the attribute information.

7. The method of claim 1, wherein moving the objects to the second page comprises reducing a size of the first page and displaying the reduced size first page in a portion of the second page.

8. The method of claim 1, wherein moving the objects to the second page comprises:
creating a folder;
moving the objects to the created folder; and
displaying the folder in the second page.

9. The method of claim 1, wherein moving the objects to the second page comprises:
creating at least one folder based on attribute information of the objects;
moving the objects to the created folder based on the attribute information; and
displaying the at least one folder, in which the objects are included, in the second page.

10. The method of claim 1, further comprising:
selecting a third page to which to move remaining objects in the first page if the second page is identified to have no space for any of the remaining objects in a process of moving the objects to the second page; and
moving the remaining objects to the third page.

11. An electronic device comprising:
a display that displays at least one page; and
a processor configured to: select a first page to delete from a plurality of pages; select a second page from the plurality of pages to which objects in the first page are to be moved; move the objects to the second page; and delete the first page.

12. The electronic device of claim 11, wherein the processor is configured to display the moved objects in the second page.

13. The electronic device of claim 11, wherein the processor is configured to identify whether any object remains in the first page and to delete the first page when the first page has no objects.

14. The electronic device of claim 11, wherein the processor is configured to: detect a movement of an input for selecting the first page; detect a release of the input; and select a page corresponding to a location of the released input as the second page.

15. The electronic device of claim 11, wherein the processor is configured to: identify priorities assigned to the plurality of pages and select at least one page, as the second page, from the plurality of pages based on the identified priorities.

16. The electronic device of claim 11, wherein the processor is configured to identify attribute information of the objects and select at least one page, as the second page, from the plurality of pages based on the attribute information.

17. The electronic device of claim 11, wherein the processor is configured to: reduce a size of the first page and display the reduced size first page in a portion of the second page.

18. The electronic device of claim 11, wherein the processor is configured to: create a folder;
move the objects to the created folder; and display the folder in the second page.

19. The electronic device of claim 11, wherein the processor is configured to: create at least one folder based on attribute information of the objects; move the objects to the created folder based on the attribute information; and display the at least one folder, in which the objects are included, in the second page.

20. The electronic device of claim 11, wherein the processor is configured to: select a third page to which to move remaining objects in the first page if the second page is identified to have no space for any of the remaining objects in the process of moving the objects to the second page; and to move the remaining objects to the third page.
